(19) United States
(12) Patent Application Publication
(10) Pub. No.: US 2026/0242611 A1
(43) Pub. Date: Aug. 20, 2026

(54) Methods to Process Reclaimed Carbon and the Resulting Milled Reclaimed Carbon and Products Containing the Same

(71) Applicant: Beyond Lotus LLC, Wilmington, DE (US)

(72) Inventor: Constantine Khripin, Chelmsford, MA (US)

(21) Appl. No.: 19/489,520

(22) PCT Filed: Jun. 26, 2024
(86) PCT No.: PCT/US2024/035543

§ 371 Date: Dec. 2, 2025

Related U.S. Application Data
(60) Provisional application No. 63/510,494, filed on Jun. 27, 2023.

(51) Int. Cl. C09C 1/48; B60C 1/00; C08K 3/04

(52) U.S. Cl. CPC C09C 1/482; B60C 1/0016; C08K 3/04; C01P 2004/62; C08K 2201/005

(57) ABSTRACT

Methods to process reclaimed carbon are described. Methods utilizing media milling to improve one or more properties of the reclaimed carbon in products, such as elastomer composites are described. The media milling utilized can include media milling that expends a specific energy of 1 kWh/kg to 10 kWh/kg of dry milled reclaimed carbon.

### BACKGROUND OF THE INVENTION

The present invention relates to methods of processing reclaimed carbon (rC). The present invention further relates to milled reclaimed carbon useful for incorporating into products, such as elastomers.

There is more and more demand and effort in the recycling of materials so as to avoid the materials being disposed of in waste fills and to avoid further depletion of natural resources.

End-of-life vehicle tires are frequently processed and reused in a wide range of end-use applications from playground equipment to concrete. However, it is desirable to recycle components of tires to obtain materials that can be combined with first-use materials to reduce the amount of new material required to produce new products.

There is a growing need for more sustainable materials and reduced carbon footprint in various industries. Thus, the use of reclaimed carbon (rC) from used tires (or other sources) as a substitute for carbon black (CB) in rubber reinforcement applications may be a promising strategy. Tires and other rubbers contain a variety of carbon blacks and other fillers having a variety of morphologies, along with to ceramic additives such as zinc oxide. Consequently, the resulting rC has a different composition and microstructure than virgin carbon black. Reclaimed carbon suffers from low rubber reinforcement, such as low tensile modulus, low tear strength, and/or low fatigue life, compared with CB with the same or about the same surface area and structure as measured by OAN. Accordingly, there is a need in the industry to develop processes that can take rC and other similar particles that are not suitable as-is for use as filler in rubber reinforcement applications and other applications so as to make them a suitable replacement or suitable partial replacement for virgin carbon black.

All of the patents and publications mentioned throughout are incorporated in their entirety by reference herein.

### SUMMARY OF THE INVENTION

A feature of the present invention is to provide methods to improve reclaimed carbon for use in products.

An additional feature of the present invention is to provide the ability to utilize reclaimed carbon and yet not interfere with the ability to produce industry acceptable products, such as elastomers.

A further feature of the present invention is to provide methods to make reclaimed carbon a more viable material for use as reinforcement grade or filler grade material in such applications as elastomers and the like.

A still further feature of the present invention is to provide methods to process the reclaimed carbon for use in a polymer matrix or elastomer matrix and substantially maintain most, if not all, of the product properties (e.g., undispersed area, abrasion volume loss, M300/M100, M300, M100).

A further feature of the present invention is to provide methods that ‘fine tune’ the reclaimed carbon in order to achieve or enhance a certain property (such as undispersed areas, M300, M100, M300/M100, or abrasion volume loss).

Also, a feature of the present invention is to provide methods to process reclaimed carbon, so that the particles in combination, for instance, with virgin carbon black can have comparable filler properties, such as, but not limited to, acceptable dispersion compared to utilizing 100% virgin carbon black.

An additional feature of the present invention is to provide a milled reclaimed carbon and to provide products containing the same.

To achieve these and other advantages, and in accordance with the purposes of the present invention, as embodied and broadly described herein, the present invention, in part, relates a method to process reclaimed carbon. The method includes milling wet reclaimed carbon to obtain milled reclaimed carbon and the milling involves or at least includes utilizing media milling that expends a specific energy of at least 1 kWh/kg or at least 1.25 kWh/kg, or at least 1.5 kWh/kg of dry milled reclaimed carbon.

In addition, the present invention relates to a method to process reclaimed carbon where the method includes at least milling wet reclaimed carbon to obtain milled reclaimed carbon, and wherein the milling at least includes media milling such that the number of collisions per kg of dry milled reclaimed carbon can result in at least 10¹³ media collisions per kg of dry milled reclaimed carbon during milling, or at least 2×10¹³ media collisions per kg of dry milled reclaimed carbon during milling, or the media milling can result in at least 5×10¹³ media collisions per kg of dry milled reclaimed carbon during milling.

The present invention further relates, in part, to milled reclaimed carbon, preferably produced by one of the methods of the present invention, and having D50 of 250-400 nm and D90 of 350-1100 nm.

Further the present invention relates, in part, to milled reclaimed carbon produced by one of the methods of the present invention, and relates to products, such as rubber products or elastomer products, that contain or utilize the milled reclaimed carbon of the present invention.

As used herein, “char” means solid material resulting from pyrolysis of rubber goods.

As used herein, “dry milled reclaimed carbon” is pyrolysis carbon that is substantially free of macroscopic contaminants and that has been milled without the use of water and optionally pelletized.

As used herein, “carbon black” means elemental carbon-containing particles of carbon coalesced into aggregates and agglomerates and obtained by partial combustion or thermal decomposition of hydrocarbons.

As used herein, “raw reclaimed carbon” is solid material resulting from pyrolysis of rubber goods that contain at least two different types of carbonaceous particulate fillers, including but not limited to carbon black (e.g., at least two different types of carbon black), in any amount.

As used herein, “processed reclaimed carbon” means raw reclaimed carbon that has been processed to remove at least one macroscopic contaminant such as fabric or wire.

As used herein, “pyrolysis carbon” includes char, raw reclaimed carbon, processed reclaimed carbon, and dry milled reclaimed carbon.

As used herein, “milled reclaimed carbon” or “milled rC” is pyrolysis carbon that is substantially free of macroscopic contaminants and that has been milled.

As used herein, “reclaimed carbon” is raw reclaimed carbon that has been processed to remove macroscopic contaminants and that has optionally been further milled. Thus, processed reclaimed carbon, milled reclaimed carbon, dry milled reclaimed carbon, and wet milled reclaimed carbon all fall under the definition of reclaimed carbon.

As used herein, “wet milled reclaimed carbon” is pyrolysis carbon that is substantially free of macroscopic contaminants and that has been milled in the presence of at least 50 wt %, preferably 65-99 wt % water, based on the total weight of materials being milled.

The method may further include removing macroscopic contaminants from the initial slurry, which may optionally have up to 35 wt % solids. Combining may further include combining at least one supplemental filler with the water to form the initial slurry. The supplemental filler may be selected from the group consisting of carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, carbon black-coated particles, and mixtures of two or more of these.

The method may further include adding at least one additional filler selected from carbon black, silicon treated carbon black, silica coated carbon black, coated carbon black particles, and precipitated silica to the milled slurry to bring the solids content of the resulting wet blended carbon mixture to 25-70 wt %. Adding may include adding an aqueous slurry comprising the at least one additional filler, adding additional water to the milled slurry, or both. The method may further include pelletizing the wet blended carbon mixture to form pellets or spray drying the wet blended carbon mixture and, optionally, drying the pellets.

The water may be a continuous stream of water, the milled slurry may be a continuous stream of the milled slurry, and combining may include metering the pyrolysis carbon into the continuous stream of water. Combining may further include metering at least one supplemental filler into the continuous stream of water. The supplemental filler may be selected from the group consisting of carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, carbon black-coated particles, and mixtures of two or more of these. The method may further include metering at least one additional filler selected from carbon black, silicon treated carbon black, silica coated carbon black, carbon black coated particles, and precipitated silica into the continuous stream of the milled slurry to bring the solids content of the resulting continuous flow of wet blended carbon mixture to 25-70 wt % or 1-35 wt %. Metering may include metering an aqueous slurry of the additional filler into the continuous stream of the milled slurry, metering additional water into the continuous stream of the milled slurry, or both.

In any of these embodiments, the method may further include granulating the wet blended carbon mixture, e.g., by pelletizing the wet blended carbon mixture to form pellets or spray drying the wet blended carbon mixture. The pellets may be dried. The milled slurry may be spray dried or its solids otherwise granulated. For example, the milled slurry may be dehydrated to a predetermined moisture level and then pelletized.

In another embodiment, the invention includes pellets produced using any combination or subcombination of the method steps above.

In any of these embodiments, the particulate filler may further include one or more supplemental fillers selected from carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures and carbon black-coated particles. The particulate filler may have a moisture content of 15 to 80 wt %, for example 40-60 wt %.

The particulate filler may be in the form of pellets. The pellets may include 15-80% water, for example, 40-60% water, or may include no more than 3% water and/or may consist substantially of particulate filler, optional water, and optional binder. A pellet may contain particulate filler according to any of these embodiments and at least one additional filler selected from carbon black, silicon treated carbon black, silica coated carbon black, carbon black-coated particles, and precipitated silica.

In another embodiment, an elastomer composite includes a mixture of an elastomer and 30-90 phr particulate filler, for example, 30-70, 35-60, or 40-55 phr. The particulate filler includes at least 10 wt % reclaimed carbon, for example, 10-100 wt %, 10-90 wt %, 15-80 wt %, 20-60 wt %, or 30-50 wt % reclaimed carbon, preferably 10-40 wt % or 20-40 wt % reclaimed carbon. The reclaimed carbon preferably has D50 of 250-400 nm, more preferably 250-320 nm, and D90 of 350 to 1100 nm, for example, 500-1100 nm. The particulate filler may further include one or more of carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, and carbon black-coated particles. In certain preferred embodiments, the particulate filler preferably includes carbon black.

In any of these embodiments, the elastomer may be selected from natural rubbers, functionalized natural rubbers, styrene-butadiene rubbers, functionalized styrene-butadiene rubbers, polybutadiene rubbers, functionalized polybutadiene rubbers, polyisoprene rubbers, ethylene-propylene copolymers, isobutylene-based rubbers, polychloroprene rubbers, nitrile rubbers, hydrogenated nitrile rubbers, polysulfide rubbers, polyacrylate elastomers, fluoroelastomers, perfluoroelastomers, and blends thereof.

In any of these embodiments, the reclaimed carbon may be wet milled reclaimed carbon. In any of these embodiments, the elastomer composite may be a vulcanized elastomer composite. A tire tread may include a vulcanizate of a mixture of the elastomer composite with a curative package. Alternatively or in addition, an article may include a vulcanizate of a mixture of the elastomer composite with a curative package. The article may be incorporated in pneumatic tires, non-pneumatic tires, or solid tires. The article may be selected from tire treads, under-treads, inner liners, sidewalls, sidewall inserts, wire-skim, and cushion gum for retread tires. The article may be selected from hoses, linings, liners, seals, gaskets, anti-vibration articles, tracks, track pads for track-propelled vehicle equipment, engine mounts, earthquake stabilizers, mining equipment screens, mining equipment linings, conveyor belts, chute liners, slurry pump liners, mud pump impellers, valve seats, valve bodies, piston hubs, piston rods, plungers, impellers for mixing slurries and slurry pump impellers, grinding mill liners, cyclones and hydrocyclones, expansion joints, linings for dredge pumps and outboard motor pumps for marine equipment, shaft seals for marine, oil, aerospace, and other applications, propeller shafts, pipe linings, engine mounts, bushings, weather stripping, windshield wipers, automotive components, seals, gaskets, housings, wheel elements, and track elements.

In another embodiment, an elastomer composite comprises a mixture of an elastomer and 30-90 phr of particulate filler. In certain embodiments, the particulate filler comprises at least 10 wt % reclaimed carbon. In any of these embodiments, the elastomer composite may be vulcanized, and/or the reclaimed carbon may be wet milled reclaimed carbon.

It is to be understood that both the foregoing general description and the following detailed description are exemplary and explanatory only and are intended to provide a further explanation of the present invention as claimed.

The accompanying drawings, which are incorporated in and constitute a part of this application, illustrate various features of the present invention and, together with the description, serve to explain the principles of the present invention.

### BRIEF DESCRIPTION OF THE DRAWING

FIG. 1 is a graph showing the plotting of volume weighted frequency vs particle size in nm, for samples taken at different residence times during the milling process, thus showing the change in particle size with residence time in the mill with milling media. The “base sample” plot describes the particle size distribution in the slurry before the start of milling.

FIG. 2 is a graph showing the amount of undispersed area in cured elastomer composites having 50 phr filler as a function of rC concentration in mixtures/blends for different rC processing methods, as indicated by the data labels. The data, in the figure, shows control mixes without rC (solid circle), media milled samples of the present invention (short-dashed circle), and blends of rC that has not been media milled (long-dashed circles). Media milling residence time is given in the data labels.

FIG. 3 is a graph showing the abrasion volume loss of compounds having 50 phr filler with various mixing methods as a function of rC concentration. The data in the graph provides control mixes without rC (solid circle), blends with media milled rC (short-dashed circle), and other rC mixing methods without media milling (long-dashed circles).

FIG. 4 is a graph showing the reinforcement index M300/M100 in cured elastomer composites having 50 phr filler, as a function of rC concentration. The data in the graph provides control mixes without rC (solid circle), blends with media milled rC (short-dashed circle), and other rC mixing methods without media milling (long-dashed circles).

FIG. 5 is a graph showing the tensile stress at 300% elongation (M300) of compounds having 50 phr filler blended with various mixing methods as a function of rC concentration. The data in the graph provides control mixes without rC (solid circle), blends with media milled rC (short-dashed circle), and other rC mixing methods without media milling (long-dashed circles).

FIG. 6 is a graph showing particle size distribution as a function of the volume % for samples having different milling times and a control distribution is also shown.

FIG. 7 is a graph showing % undispersed area as a function of particle size distribution (D90) for samples milled at different times (in minutes, RT=residence time) and speeds.

FIG. 8 is a graph showing abrasion volume loss as a function of particle size distribution (D90) for samples milled at different times (in minutes, RT=residence time) and speeds.

FIG. 9 is a graph showing M100 as a function of particle size distribution (D90) for samples milled at different times (in minutes, RT=residence time) and speeds.

FIG. 10 is a graph showing % undispersed area as a function of filler loading (wt %) for samples prepared with (filled circles) and without (open circles) media milling.

FIG. 11 is a graph showing abrasion volume loss (mm³) as a function of filler loading (wt %) for samples prepared with (filled circles) and without (open circles) media milling.

The figures are not to scale and are provided as simplified views and do not necessarily show all possible embodiments or components that can be present.

### DETAILED DESCRIPTION OF THE INVENTION

The present invention relates, in part, to methods to improve the condition of the reclaimed carbon so that one or more properties of the product containing the reclaimed carbon are maintained or substantially maintained as compared to when 100% virgin carbon black is used for the same product.

The present invention relates further to a method to process reclaimed carbon where the method includes at least milling wet reclaimed carbon to obtain milled reclaimed carbon, and wherein the milling at least includes media milling that expends a specific energy of at least 1 kWh/kg, or at least 1.25 kWh/kg, or at least 1.5 kWh/kg of dry milled reclaimed carbon, for example, 1 kWh/kg to 10 kWh/kg or 1.25 kWh/kg to 3.5 kWh/kg or 1.5 kWh/kg to 5 kWh/kg or 1 kWh/kg to 3.1 kWh/kg, where media milling is conducted with milling media having a diameter of 2 mm or less.

Additionally or alternatively, the present invention relates further to a method to process reclaimed carbon where the method includes at least milling wet reclaimed carbon to obtain milled reclaimed carbon, and wherein the milling at least includes media milling such that the number of collisions per kg of dry milled reclaimed carbon can result in at least 10¹³ media collisions per kg of dry milled reclaimed carbon during milling, or at least 2×10¹³ media collisions per kg of dry milled reclaimed carbon during milling, for example, 3×10¹³ media collisions per kg to 10¹⁴ media collisions per kg, or 4×10¹³ media collisions per kg to 8×10¹³ media collisions per kg, or 5×10¹³ media collisions per kg to 6×10¹³ media collisions per kg of dry milled reclaimed carbon during milling.

Other aspects and options relating to the methods of the present invention are further described herein.

With the present invention, it was discovered, unexpectedly, that milling rC utilizing media milling techniques (e.g., as described herein) as compared to un-milled rC or rC without media or with media having a diameter greater than 2 mm, can enhance or improve one or more certain rubber or elastomer properties (herein referred to at time as ‘rubber properties). With the present invention, it was discovered that milling rC utilizing media milling techniques can enhance or improve certain rubber properties based on the time a unit element of slurry volume spends within the media mill (residence time). Further, certain rubber properties are better enhanced at lower milling times and other rubber properties at higher milling times, and for all rubber properties, it was discovered that generally rubber properties are not further improved beyond a certain milling time and thus there is a range of milling times that are advantageous to achieve or enhance certain properties and avoid over-milling of the rC. As described herein, the media milled rC and the method to form the same of the present invention were compared to N550 virgin carbon black (as the control) as this type of carbon black, in the past, has proven to be difficult to replace even partially with rC, even milled rC.

The starting reclaimed carbon or rC (to be subjected to milling), such as rC aggregates, are commercially available. Generally, the rC aggregates result from the pyrolysis of tires and/or other rubber materials that contained filler materials or reinforcement materials, such as carbon black. The rC is made primarily of carbon black that was used to reinforce rubber. The rC can contain components that can pyrolyze, such as the rubber components. The rC can be processed reclaimed carbon where the raw reclaimed carbon has been processed to remove or substantially remove at least one macroscopic contaminant such as fabric or wire. The reclaimed carbon is commercially available from such suppliers as Reoil Sp. z o.o., Scandinavian Enviro Systems AB, Pyrum Innovations AG, or Bolder Industries or CBp Cyprus Ltd.

The rC may be processed to remove macroscopic contaminants. For example, magnetic separation techniques known to those of skill in the art may be used to remove wires and other macroscopic metallic contaminants. Filters or screens may be used to remove fabric and other non-magnetic macroscopic contaminants. The rC may be processed before being combined with the water to form the initial slurry and/or the initial slurry may be processed to removed macroscopic contaminants.

Alternatively or in addition, the rC or pyrolysis carbon may be processed to remove ash, for example, by washing the pyrolysis carbon with acid or by using an ion exchanger. Exemplary methods are described in US20150307714, CN101357758, and WO2021/005124, the contents of all of which are incorporated herein by reference.

As an example, the starting reclaimed carbon particles (prior to milling as described herein) can have a mesh size of 5× to 10× smaller than the media used. Other mesh sizes above or below this range can be utilized.

For milling, the reclaimed carbon, in particulate form, is a wet reclaimed carbon.

The wet reclaimed carbon subjected to milling can be prepared by wetting reclaimed carbon with an aqueous solution, such as water. The wetting of the reclaimed carbon generally occurs prior to the reclaimed carbon being introduced into the mill. The wetting can be such that a mixture of reclaimed carbon and water are formed, such as a slurry. The slurry can have at least 1 wt % solids (e.g., at least 1 wt % reclaimed carbon). The slurry can have from about 1 wt % to 35 wt % or more solids content (based on the total weight of the slurry). The slurry can be 1 wt % to 30 wt %, from 1 wt % to 25 wt %, from 1 wt % to 20 wt %, from 1 wt % to 15 wt %, from 1 wt % to 10 wt %, from 1 wt % to 5 wt %, from 5 wt % to 35 wt %, from 10 wt % to 35 wt %, from 15 wt % to 35 wt %, from 20 wt % to 35 wt %, from 25 wt % to 35 wt %, or any range based upon any two values described herein.

The milling includes at least one milling step that utilizes media milling employing milling media having a diameter of 2 mm or less. If more than one media milling step is used, the type of media milling with respect to the media or type of milling or milling time, or number or size of media can be the same or different.

The media milling can be or include agitated ball milling, planetary ball milling, or centrifugal ball milling.

One preferred media milling is agitated ball milling.

The media (which can be considered grinding media), as one option, utilizes a media that is solid balls.

The solid balls, for examples, can have an average size that is from about 0.25 mm to 2 mm. The average size can be from 0.3 mm to 1.75 mm, or 0.4 mm to 1.5 mm, or from 0.5 mm to 1 mm or from 0.6 mm to 1 mm or from 0.7 mm to 1 mm, or from 0.8 mm to 1.5 mm.

As an option, the media for the milling can be a size such that the particle size of the starting reclaimed carbon is about 3 times to about 10 times smaller or about 5 times to 10 times smaller (e.g., 4 times to 5 times smaller) than the media size utilized (e.g., average media size utilized).

The solid balls can metal balls, glass balls, ceramic balls, or polymeric balls. Specific examples include, but are not limited to, steel (e.g., chrome steel, or stainless steel such as 304SS and 316SS) or ceramics (e.g., agate, alumina, yttria stabilized zirconia, zirconium silicate, zirconia toughened alumina, and tungsten carbide).

The milling media can be loaded into the mill so that the volume loading is from 50% to 98% in a mill. The volume loading can be below 50% or higher than 90% if needed or desired. The volume loading can be from 50% to 95%, or from 60% to 90%, from 70% to 90%, from 80% to 90%, from 50% to 80%, from 50% to 70%, from 50% to 60%, or any range based upon any two values described herein. The volume loading is based on the total volume (space) available in the mill for milling.

The media milling is operated such that the milling expends a specific energy of at least 1 kWh/kg, or at least 1.25 kWh/kg, or at least 1.5 kWh/kg of dry milled reclaimed carbon, for example, 1 kWh/kg to 10 kWh/kg or 1.25 kWh/kg to 3.5 kWh/kg or 1.5 kWh/kg to 5 kWh/kg or 1 kWh/kg to 3.1 kWh/kg or from 2.5 kWh/kg to 3.5 kWh/kg, or from 4 kWh/kg to 5 kWh/kg, or any range based upon any two values described herein.

The specific energy used by the mill can be used as a proxy for extent of milling. The amount of kWh expended can be calculated per kg of dry product (Pₘ=tₘ*P/mₚ, where tₘ is the milling time, P is the average mill specific energy, and mₚ is the batch dry weight) at various residence times. Similarly, the approximate number of media collisions can be calculated:

$$( {C}_{m} = \frac{\frac{1}{2} ( {t}_{m} {v}_{m} {n}_{b} )}{{m}_{p} {d}_{b}}$$

where vₘ is the tip velocity, n_{b} is the number of beads, d_{b} is the bead diameter). For example, in the milling apparatus used in Example 1, the relationship between specific energy, number of collisions and residence time is as follows:

TABLE 1
Relationship between residence time, specific energy expended per
kg of dry product, and media collisions per kg of dry product.

| Residence time | Pₘ | Cₘ |
|---|---|---|
| min | kWh/kg | number/kg |
| 0.5 | 0.75 | 5.87E+12 |
| 1 | 1.51 | 1.17E+13 |
| 2 | 3.02 | 2.35E+13 |
| 5 | 7.54 | 5.67E+13 |
| 10 | 15.08 | 1.13E+14 |
| 20 | 30.17 | 2.27E+14 |
| 40 | 60.33 | 4.54E+14 |

The media milling can be characterized by number of collisions per kg of dry milled reclaimed carbon. The media milling utilized can result in at least 10¹³ media collisions per kg of dry milled reclaimed carbon during milling, or at least 2×10¹³ media collisions per kg of dry milled reclaimed carbon during milling, for example, 10¹³ media collisions per kg to 10⁴ media collisions per kg, 3×10¹³ media collisions per kg to 10¹⁴ media collisions per kg, or 4×10¹³ media collisions per kg to 8×10¹³ media collisions per kg, or 5×10¹³ media collisions per kg to 6×10¹³ media collisions per kg of dry milled reclaimed carbon during milling

For any of the methods of the present invention, the milling utilized can be such that the milled reclaimed carbon has, a particle size distribution (PSD) and has a particle size of D50 that has a value of 250 nm to 400 nm, preferably 250-320 nm. Similarly, or in addition, the PSD may have a D90 of 350 nm to 1100 nm, for example, 500-1100 nm, 600 to 1000 nm, 700 to 900 nm, or 800 to 1100 nm. The particle size distribution is measured by analytical centrifugation (disc centrifuge photosedimentometry) of the milled slurry, as described in Example 1. In this method, termed PSD Method 1, aqueous particulate slurry (14 wt % solids) is diluted to 2000 ppm by DI water containing 600 ppm Triton X100 surfactant. The diluted solution is then mixed by a DISPERMAT LC55 mixer equipped with a lightweight 30 mm diameter 18 tooth impeller at 800 RPM for 5 minutes. Then the solution is stirred using a magnetic stir bar on a stir plate for 24 hours. The sample solution is then further diluted to 400 ppm using DI water containing 400 ppm Triton X100 surfactant and left to rotate in a 40 ml vial on a roller until measurement. Disc centrifuge (DC24000, CPS Instruments) measurements are carried out at 5000 RPM. First, 24%, 22%, 20%, 18%, 16%, 14%, 12%, 10%, 8% of sucrose solution in DI water is injected sequentially into the disc (1.6 ml for each), then 1 ml dodecane is injected to seal the gradient. The gradient is given 1 hour to stabilize before measurements. In the disc centrifuge measurements, sample density and refractive index are set as 1.86 g/cm³ and n=1.84+0.846i. The results represent the equivalent sedimentation result of a spherical particle with a density of 1.86 g/cm³ and a refractive index of n=1.84+0.846i. All measurements are stopped immediately after the signal touches the baseline.

The milling can be characterized by one or more properties achieved by milling of the reclaimed carbon based on the present invention.

For instance, the milling is such that a rubber sample having 20 to 60 phr (e.g., 20 phr, or 25 phr, or 30 phr, or 35 phr, or 40 phr or 30-55 phr or 40 to 50 phr) of the milled reclaimed carbon results in up to 8% or up to 5% undispersed area, or from 1% to 7% or from 1.5% to 6%, or from 1.75% to 4% (dispergrader %), especially when prepared using techniques in which wet pellets are combined with elastomer. Alternatively, a rubber sample having 20 to 80 phr of particulate filler, for example, 30-70 phr, 40 to 60 phr, or 45-55 phr of particulate filler, of which 10-40 wt % is media milled reclaimed carbon, e.g., 15-35 wt % or 20 to 30 wt %, has up to 3% undispersed area, for example, 1%-3% undispersed area. In certain embodiments, the particulate filler is a blend of media milled reclaimed carbon and carbon black, for example, a carbon black having BET surface area from 35 to 110 m²/g, e.g., an N300 or N500 series carbon black, for example, N330 or N550 carbon black.

Dispergrader % is calculated as follows. The cured rubber sample is sectioned using a razor blade fixed in a manual cutting jig. The sample is mounted and imaged on a Dispergrader instrument (Alpha Technologies). The following settings are used: “filler volume fraction”, 20%; “exposure time”, 40 ms; “color channel for analysis”, “blue”; “threshold for dispersion calculation”, 23 m; nodge to agglomerate fraction, 1; white area threshold, 0. The quantity reported by the Alpha Technologies as “White Area, %” is interpreted as “undispersed area”.

As a further example, the milling is such that a rubber sample having 20 to 60 phr (e.g., 20 phr, or 25 phr, or 30 phr, or 35 phr, or 40 phr) of the milled reclaimed carbon results in an abrasion volume loss that is no more than 10% greater or within 5% of a comparative rubber sample having N550 carbon black instead of the milled reclaimed carbon. The comparative rubber sample having N550 carbon black can be considered a ‘control sample’ and the control sample has the same phr of N550 carbon black as used for the rubber sample with reclaimed carbon and all other ingredients are the same but for the use of carbon black instead of reclaimed carbon. DIN Abrasion is evaluated according to the standard ASTM D5963 Rotating Method. Alternatively or in addition, the milling is such that a rubber sample having 20 to 60 phr (e.g., 20 phr, or 25 phr, or 30 phr, or 35 phr, or 40 phr) of filler including a blend of N330 carbon black and from 10 wt % to 40 wt % of the milled reclaimed carbon results in an abrasion volume loss that is no more than 10% greater or within 5% of a comparative rubber sample having 100% N330 carbon black instead of a blend with the milled reclaimed carbon, especially when prepared using techniques in which wet pellets are combined with elastomer. Alternatively, a rubber sample having 20 to 80 phr of particulate filler, for example, 30-70 phr, 40 to 60 phr, or 45-55 phr of particulate filler, of which 10-40 wt % is media milled reclaimed carbon, e.g., 25-40 wt %, 15-35 wt % or 20 to 30 wt %, has an abrasion loss of 90 to 100 mm³, for example, 91-95 mm³, when measured according to ASTM D5963. In certain embodiments, the particulate filler is a blend of media milled reclaimed carbon and carbon black, for example, a carbon black having BET surface area from 35 to 110 m²/g, e.g., an N300 or N500 series carbon black, for example, N330 or N550 carbon black.

As a further example, the milling can be such that a rubber sample having 20 to 40 phr of the milled reclaimed carbon results in a M300/M100 ratio that is either a) no more than 10% less or within 5% of a comparative rubber sample having N550 carbon black (control sample) instead of the milled reclaimed carbon or b) 4.5 to 5. Tensile stress (including M300 or M100) is tested per ASTM D412 Type C. 6 dumbbells are used instead of 5. M300 is the tensile stress at 300% elongation, and M100 is the tensile stress at 100% elongation.

As a further example, the milling can be such that a rubber sample having 20 to 40 phr of the milled reclaimed carbon results in a M300 (MPa) or maximum load (N) that is no more than 10% less or no more than 5% less of a comparative rubber sample having N550 carbon black instead of the milled reclaimed carbon.

The present invention further relates to a milled reclaimed carbon produced by any method of the present invention. The milled reclaimed carbon can be characterized by any one or more of the properties and/or characteristics described herein.

As indicated, with the present invention, it was unexpectedly discovered that certain residence times for media milling are more appropriate to certain rubber properties. To make this determination, the milled materials of the present invention were tested in SBR composites as described in the Example section. To further show that media milled material of the present invention contributed to the rubber properties, the media milled material, as shown in the Example section, was compared to fluffy (unmilled) rC and wet mixed rC pellets (unmilled) and also compared to N550 virgin carbon black samples.

With the present invention, various relationships were discovered based on the phr of media milled rC and preferably based on milling time.

For the rubber property of undispersed area (Dispergrader %) of filler in an elastomer composite, the undispersed area (per the Dispergrader %) based on the media milled rC of certain embodiments can be characterized based on Equation 2: Undispersed Area (UA)≤3.35−(0.04*phr rC). The phr rC is media milled rC per the present invention and can be an amount ranging from 10 phr to 50 phr or from 10 phr to 40 phr, from 10 phr to 35 phr, from 10 phr to 30 phr, from 5 phr to 55 phr, from 7 phr to 20 phr. The media milled rC may be part of a blend with additional particulate filler, for example, carbon black, e.g., a carbon black having BET surface area from 35 to 110 m²/g, e.g., an N300 or N500 series carbon black, for example, N330 or N550 carbon black. The total amount of filler may be from 20 to 80 phr, for example, from 30 to 70 phr, from 40 to 60 phr, or from 45 to 55 phr. The media milled rC may be 10-40 wt % of the total filler, for example, 15 to 35 wt % or 20 to 30 wt %.

For the rubber property of abrasion volume loss (mm³) in an elastomer composite, the abrasion volume loss based on the media milled rC of certain embodiments can be characterized based on Equation 3: Abrasion Volume Loss (AVL)≤100+(0.1*phr rC) (normalized to a control sample produced in the same way but with N550 carbon black in place of the media milled rC). The phr rC is media milled rC per the present invention and can be an amount ranging from 10 phr to 50 phr or from 10 phr to 40 phr, or from 10 phr to 30 phr. Equation 3A: AVL≤100−(0.43*phr rC) (normalized to N550 control) is achievable. The phr rC is media milled rC per the present invention and can be an amount ranging from 10 phr to 50 phr or from 10 phr to 40 phr, from 10 phr to 35 phr, from 10 phr to 30 phr, from 5 phr to 55 phr, from 7 phr to 20 phr. The media milled rC may be part of a blend with additional particulate filler, for example, carbon black, e.g., a carbon black having BET surface area from 35 to 110 m²/g, e.g., an N300 or N500 series carbon black, for example, N330 or N550 carbon black. The media milled rC may be 10-40 wt % of the total filler, for example, 15 to 35 wt % or 20 to 30 wt %.

For the rubber property of strain rigidity (M300/M100 index) in an elastomer composite, the strain rigidity (M300/M100 index) based on the media milled rC of certain embodiments, e.g., with 2 min residence time, can be characterized based on Equation 4: M300/M100 index≥100−(0.01*phr rC) (normalized to N550 control). The phr rC is media milled rC per the present invention and can be an amount ranging from 10 phr to 50 phr or from 10 phr to 40 phr, or from 10 phr to 30 phr. Equation 4A: M300/M100 index≥100+(0.38*phr rC) (normalized to N550 control) is achievable. The phr rC is media milled rC per the present invention and can be an amount ranging from 10 phr to 50 phr or from 10 phr to 40 phr, from 10 phr to 35 phr, from 10 phr to 30 phr, from 5 phr to 55 phr, from 7 phr to 20 phr. The media milled rC may be part of a blend with additional particulate filler, for example, carbon black, for example, a carbon black having BET surface area from 35 to 110 m²/g, e.g., an N300 or N500 series carbon black, for example, N330 or N550 carbon black. The media milled rC may be 10-40 wt % of the total filler, for example, 15 to 35 wt % or 20 to 30 wt %.

For the rubber property of high strain rigidity or tensile stress (M300) in an elastomer composite, the high strain rigidity or tensile stress (M300) based on the media milled rC of certain embodiments can be characterized based on Equation 5: M300≥100−(0.15*phr rC) (normalized to N550 control). The phr rC is media milled rC per the present invention and can be an amount ranging from 10 phr to 50 phr or from 10 phr to 40 phr, or from 10 phr to 30 phr. The media milled rC may be part of a blend with additional particulate filler, for example, carbon black, e.g., a carbon black having BET surface area from 35 to 110 m²/g, e.g., an N300 or N500 series carbon black, for example, N330 or N550 carbon black. The media milled rC may be 10-40 wt % of the total filler, for example, 15 to 35 wt % or 20 to 30 wt %. Equation 5A: M300≥100+(0.38*phr rC) (normalized to N550 control) is achievable. In one embodiment, a method of processing particulate carbon includes combining reclaimed carbon with water to form a mixture to form an initial slurry having 1-35 wt % solids and media milling the reclaimed carbon to form a media milled slurry of wet milled reclaimed carbon and water.

The pyrolysis carbon can be combined with water to form an initial slurry having a solids loading of 1-35%, for example, 5-30%, 7-25%, 10-20%, or 15-25% by weight. The loading is preferably coordinated with the loading needs of downstream processes including milling and optional pelletizing.

The initial slurry may contain one or more supplemental fillers that may also benefit from being co-milled with the pyrolysis carbon. Any particulate filler that provides reinforcement or other beneficial properties to rubber may be employed. Exemplary supplemental fillers include but are not limited to carbon black, silicon treated carbon black, silica coated carbon black, precipitated silica, hydrothermal carbon (i.e., carbonaceous material produced by hydrothermal carbonization of lignin or other biomass, for example, as described in U.S. Ser. No. 10/428,218 or U.S. Ser. No. 10/035,957, the contents of both of which are incorporated herein by reference), engineered polysaccharides such as those described in US2020/181370 and US2020/190270, the contents of both of which are incorporated herein by reference, and graphene, graphene oxide, reduced graphene oxide, nanocellulose, lignin, clays, nanoclays, metal oxides, metal carbonates, single walled carbon nanotubes, multi walled carbon nanotubes, carbon nanostructures such as those described in US2014/0093728, the entire contents of which are incorporated herein by reference, and carbon-black coated particles such as those described in U.S. Ser. No. 10/519,298, the entire contents of which are incorporated herein by reference. Preferably, macroscopic contaminants are removed from the pyrolysis carbon, either in the dry or slurry state, prior to combining the pyrolysis carbon with the one or more supplemental fillers. The supplemental filler(s) may be combined with the pyrolysis carbon in the dry state or separately charged into the water, before, after, or simultaneously with the pyrolysis carbon to form the initial slurry. To avoid any segregation that may occur in dry mixtures of pyrolysis carbon and supplemental filler, the supplemental filler(s) are preferably charged directly into the water or initial slurry separately from the pyrolysis carbon. The ratio of pyrolysis carbon and supplemental filler in the initial slurry can be any range suitable for the desired end use application and to maintain acceptable viscosity of the initial slurry so that it can be milled. In certain preferred embodiments, the supplemental filler is virgin carbon black, for example, a carbon black having BET surface area from 35 to 110 m²/g, e.g., an N300 or N500 series carbon black, for example, N330 or N550 carbon black, and the reclaimed carbon is used in an amount of 10-40% of the total filler by weight, for example 25-40% by weight, 15 to 35 wt %, or 20 to 30 wt %. In a continuous process, the supplemental filler may be continuously metered into the initial slurry or into the continuous stream of water as a powder or as an aqueous slurry of supplemental filler (or more than one slurry if more than one supplemental filler is used). One of skill in the art will recognize that the appropriate loading for milling will depend on the nature of the supplemental filler. For example, carbon nanotubes will increase slurry viscosity at very low loadings, while higher loadings of precipitated silica may not increase viscosity dramatically.

An additional filler may also be added to the milled slurry. Such additional filler preferably does not require additional milling. Exemplary additional fillers for addition to the milled slurry include but are not limited to carbon black, silica coated carbon black, silica treated carbon black, precipitated silica, carbon black-coated particles such as those described in U.S. Ser. No. 10/519,298, and mixtures of two or more of these. Depending on the solids loading of the milled slurry, it may also be desirable to add water along with the additional filler to adjust the solids loading of the resulting wet blended carbon mixture. Alternatively or in addition, the additional filler may be added to the milled slurry as an aqueous slurry. In a continuous process, the additional filler may be continuously metered into the initial slurry or into the continuous stream of water as a powder or as an aqueous slurry of additional filler. The total filler loading may be such that the wet blended carbon mixture may be readily formed into pellets or spray dried. To form pellets, the additional filler and optional water added to the milled slurry may bring the solids content of the resulting wet blended carbon mixture to 25-70 wt %, for example, 30-65 wt %, 35-60 wt %, or 40-50 wt %. For spray drying, the additional filler and optional water added to the milled slurry may bring the solids content of the resulting wet blended carbon mixture to 1-30 wt %, for example, 1-10 wt %, 5-15 wt %, or 8-25 wt %. In certain preferred embodiments, the additional filler is virgin carbon black, for example, a carbon black having BET surface area from 35 to 110 m²/g, e.g., an N300 or N500 series carbon black, for example, N330 or N550 carbon black, and the reclaimed carbon is used in an amount of 10-40% of the total filler, for example 25-40% by weight, 15 to 35 wt %, or 20 to 30 wt %. For spray drying, it may be desirable to omit the additional filler. One of skill in the art will recognize how to adjust the total filler loading to prepare desirable pellets or the optimal loading for spray drying in conventional apparatus. The filler(s) that is added to the milled slurry may be the same or different as any filler(s) added to the initial slurry.

Carbon black for use in any of the embodiments herein include but are not limited to ASTM N100 series-N900 series carbon blacks, for example N100 series carbon blacks, N200 series carbon blacks, N300 series carbon blacks, e.g., N330 carbon black, N500 series carbon blacks, e.g., N550 carbon black, N600 series carbon blacks, N700 series carbon blacks, N800 series carbon blacks, or N900 series carbon blacks. Alternatively or in addition, such carbon blacks may have a BET surface area, as measured by ASTM 6556, of 35-110 m²/g. for example, 35-65 m²/g, 65-90 m²/g, or 90-110 m²/g. Carbon blacks sold under the Regal®, Black Pearls®, Spheron®, Sterling®, and Vulcan® trademarks available from Cabot Corporation, the Raven®, Statex®, Furnex®, and Neotex® trademarks and the CD and HV lines available from Birla Carbon (Columbian Chemicals); and the Corax®, Durax®, Ecorax®, and Purex® trademarks and the CK line and other carbon blacks available from Orion Engineered Carbons, and other fillers suitable for use in rubber or tire applications, may also be exploited for use with various embodiments. Carbon blacks may be chemically functionalized. Suitable chemically functionalized carbon blacks include those disclosed in WO 96/18688 and US2013/0165560, the disclosures of which are hereby incorporated by reference.

The carbon black may have a statistical thickness surface area (STSA, ASTM Standard D6556) of at least about 15 m²/g, for example, from about 15 m²/g to about 240 m²/g, e.g., from about 35 m²/g to about 230 m²/g, from about 50 m²/g to about 200 m²/g, from about 60 m²/g to about 180 m²/g, from about 100 m²/g to about 200 m²/g.

Carbon blacks having any of the above surface areas may additionally have a structure, as given by the oil adsorption number for the compressed carbon black (COAN, ASTM D3493), of from about 50 to about 115 mL/100 g, for example, from about 65 to about 75 mL/100 g, from about 60 to 95 mL/100 g, from about 75 to about 85 mL/100 g, from about 85 to about 95 mL/100 g, from about 95 to about 105 mL/100 g, or from about 105 to about 115 mL/100 g.

Mixtures of any of these carbon blacks may be employed.

The materials described herein as silicon-treated carbon blacks are not limited to carbon black aggregates which have been coated or otherwise modified. They also may be a different kind of aggregate having two phases. One phase is carbon, which will still be present as graphitic crystallite and/or amorphous carbon, while the second phase is silica (and possibly other silicon-containing species). Thus, the silicon-containing species phase of the silicon-treated carbon black is an intrinsic part of the aggregate; it is distributed throughout at least a portion of the aggregate. A variety of silicon-treated blacks are available from Cabot Corporation under the Ecoblack™ name and are described in more detail in U.S. Pat. No. 6,028,137. It will be appreciated that the multiphase aggregates are quite different from the silica-coated carbon blacks mentioned above, which consist of pre-formed, single phase carbon black aggregates having silicon-containing species deposited on their surface. Such carbon blacks may be surface-treated in order to place a silica functionality on the surface of the carbon black aggregate as described in, e.g., U.S. Pat. Nos. 6,929,783, 6,541,113 and 5,679,728.

Suitable precipitated silicas for use in any of the embodiments herein include both highly dispersible (HDS) granules and non-HDS precipitated silicas. Precipitated silica may have been chemically treated to include functional groups such as coupling agents bonded (attached (e.g., chemically attached) or adhered (e.g., adsorbed)) to the silica surface. Examples of suitable grades of HDS include Perkasil® GT 3000GRAN silica from WR Grace & Co, Ultrasil® 7000 silica from Evonik Industries, Zeosil® 1165 MP and 1115 MP silica from Solvay S.A., Hi-Sil® EZ 160G silica from PPG Industries, Inc., and Zeopol® 8741 or 8745 silica from Evonik Industries. Examples of suitable grades of conventional (non-HDS) precipitated silica include Perkasil® KS 408 silica from WR Grace & Co, Zeosil® 175GR silica from Solvay S.A., Ultrasil® VN3 silica from Evonik Industries, and Hi-Sil® 243 silica from PPG Industries, Inc. Examples of suitable grades of hydrophobic precipitated silica include Agilon@400, 454, or 458 silica from PPG Industries, Inc. and Coupsil® silicas from Evonik Industries, for example Coupsil® 6109 silica.

The wet blended carbon mixture may be densified, e.g., granulated or pelletized. Any densification or pelletization method known to those of skill in the art may be employed. For example, the methods of U.S. Pat. No. 2,065,371 to Glaxner may be employed. In general, the wet blended carbon mixture is formed into beads, which may then be optionally dried to reduce the water content to at most 1% to form blended carbon pellets. In addition to the water already present in the wet blended carbon mixture, a wide variety of binder additives are known to be useful in the wet pelletization process to further improve the handling characteristics of the resulting pellets. Such additives include but are not limited to hygroscopic organic liquids such as ethylene glycol, carbohydrates (e.g., sugar, molasses, soluble starches, saccharides, lignin derivatives), rosin, sulfonate and sulfate anionic surfactants, fatty amine ethoxylate nonionic surfactants, sodium ligno sulfonates, silanes, sucrose, alkyl succinimides, alkylated succinic esters, and polyethylene oxide-co-polydimethyl siloxane surfactants. Alternatively or in addition, the pellets need not be dried and may be used wet, in which case it may not be necessary to use a binder. For example, wet pellets may have a moisture content of 15-80 wt %, for example 40-60 wt %.

The resulting particulate filler, in the form of wet pellets or dry pellets or some other form (e.g., a slurry prior to pelletization or other drying method), on a dry basis, may comprise 2-100 wt %, for example 5-98 wt % or 8-90 wt %, 10-60 wt %, 15-50 wt %, 10-100 wt % or 15-60 wt %, 10-90 wt %, 15-80 wt %, 20-60 wt %, or 30-50 wt %, or 20-50 wt %, reclaimed carbon, preferably wet milled reclaimed carbon, and with the balance being a filler other than reclaimed carbon, e.g. one or more of the additional and/or supplemental fillers listed above, e.g., carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, and carbon black-coated particles. In certain preferred embodiments, the additional and/or supplemental filler is virgin carbon black, for example, N300 or N500 series carbon black, e.g., N550 or N330 carbon black, and the reclaimed carbon is present in the pellet in an amount of 10-40%, for example 25-40%, 15 to 35%, or 20 to 30% by weight of the total filler in the pellet. As noted above, the pellets may also contain a binder.

Alternatively or in addition, the wet blended carbon mixture may be spray dried using any spray drying apparatus known to those of skill in the art. The resulting spray dried particles, on a dry basis, may comprise 2-100% reclaimed carbon, for example 5-98 wt % or 8-90 wt %, 10-60 wt %, 15-50 wt %, 10-100 wt %, 15-60 wt %, 10-90 wt %, 15-80 wt %, 20-60 wt %, or 30-50 wt %, or 20-50 wt % reclaimed carbon, preferably wet milled reclaimed carbon, and 0-98%, e.g., 2 wt %-95 wt %, e.g., 10 wt % to 92 wt %, 40 to 90 wt %, or 50 wt % to 80 or 85 wt %, additional filler selected from carbon black, silica coated carbon black, silica treated carbon black, precipitated silica, carbon black-coated particles and mixtures of two or more of these, and 0-98%, e.g., 2 wt %-95 wt %, e.g., 10 wt % to 92 wt %, 40 to 90 wt %, or 50 wt % to 80 or 85 wt %, one or more supplemental fillers selected from to carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, and carbon black-coated particles. In certain preferred embodiments, the additional and/or supplemental filler is virgin carbon black, for example, N300 or N500 series carbon black, e.g., N550 or N330 carbon black, and the reclaimed carbon is present in the spray dried particle in an amount of 10-40% by weight, for example, 25-40%, 15 to 35%, or 20 to 30% by weight.

The wet pellets, dried pellets, and/or spray dried particles according to the various embodiments herein may be combined with elastomer to form elastomer composites. The resulting elastomer composite may include 30-90 phr particulate filler, for example, 30-70, 35-60, or 40-55 phr particulate filler. The particulate filler may include 2-100% reclaimed carbon, for example 5-98 wt % or 8-90 wt %, preferably 10-100 wt %, 10-90 wt %, 15-80 wt %, 20-60 wt %, or 30-50 wt % reclaimed carbon. In certain preferred embodiments, the additional and/or supplemental filler is virgin carbon black, for example, N300 or N500 series carbon black, e.g., N550 or N330 carbon black, and the reclaimed carbon is present in the pellet in an amount of 10-40% by weight, for example, 25-40%, 15 to 35%, or 20 to 30% by weight, of the total filler in the pellet. Both natural rubber of any grade and synthetic elastomer may be used. Blends of elastomers may also be employed. For example, the wet pellets, dried pellets and/or spray dried particles may be combined with an elastomer to form a masterbatch, which is then combined with additional elastomer of the same or different composition. Alternatively or in addition, two or more elastomers may be blended prior to mixing with the pellets. Alternatively or in addition, the elastomer composite may also contain one or more fillers aside from reclaimed carbon, including any of the particulate fillers listed elsewhere herein and any other fillers known to those of skill in the art for use in elastomer composites. Such fillers may be in a mixture or pellet with the milled reclaimed carbon or may be added to the elastomer separately from any of the wet pellets, dried pellets, and/or spray dried particles according to the various embodiments herein.

Exemplary classes of elastomers include but are not limited to rubbers, polymers (e.g., homopolymers, copolymers and/or terpolymers) of 1,3-butadiene, styrene, isoprene, isobutylene, 2,3-dialkyl-1,3-butadiene, where alkyl may be methyl, ethyl, propyl, etc., acrylonitrile, ethylene, propylene, and the like. The elastomer may have a glass transition temperature (Tg), as measured by differential scanning calorimetry (DSC), ranging from about −120° C. to about 50° C. Examples include, but are not limited to, styrene-butadiene rubbers (SBR), natural rubbers and their functionalized derivatives such as epoxidized and chlorinated rubber, polybutadiene rubbers, polyisoprene rubbers, ethylene-propylene copolymers (e.g., EPDM), isobutylene based rubbers (e.g., butyl rubber), polychloroprene rubbers, nitrile rubbers, hydrogenated nitrile rubbers, polyisoprene rubbers, polysulfide rubbers, polyacrylate elastomers, fluoroelastomers, perfluoroelastomers, and the oil extended derivatives of any of them. Blends and/or functionalized derivatives of any of the foregoing may also be used. Natural rubber may also be treated to chemically or enzymatically modify or reduce various non-rubber components.

Particular suitable synthetic rubbers include: copolymers of from about 10 to about 70 percent by weight of styrene and from about 90 to about 30 percent by weight of butadiene such as copolymer of 19 parts styrene and 81 parts butadiene, a copolymer of 30 parts styrene and 70 parts butadiene, a copolymer of 43 parts styrene and 57 parts butadiene and a copolymer of 50 parts styrene and 50 parts butadiene; polymers and copolymers of conjugated dienes such as polybutadiene, polyisoprene, polychloroprene, and the like, and copolymers of such conjugated dienes with an ethylenic group-containing monomer copolymerizable therewith such as styrene, methyl styrene, chlorostyrene, acrylonitrile, 2-vinyl-pyridine, 5-methyl-2-vinylpyridine, 5-ethyl-2-vinylpyridine, 2-methyl-5-vinylpyridine, allyl-substituted acrylates, vinyl ketone, methyl isopropenyl ketone, methyl vinyl ether, alpha-methylene carboxylic acids and the esters and amides thereof such as acrylic acid and dialkylacrylic acid amide. Also suitable for use herein are copolymers of ethylene and other high alpha olefins such as propylene, 1-butene and 1-pentene.

The elastomer composite may further comprise additives to facilitate mixing, promote vulcanization, or confer particular properties on a vulcanizate of the elastomer composite. Numerous additives are well known to those skilled in the art and include, for example, adhesion promoters, antioxidants, antiozonants, coupling agents, curatives, degradation inhibitors, plasticizers, processing aids (e.g., liquid polymers, oils and the like), oil extenders, wax, resins, flame-retardants, extender oils, lubricants, tackifiers, vulcanization activators such as zinc oxide and fatty acids, vulcanization accelerators, and a mixture of any of them. Exemplary additives include but are not limited to zinc oxide and stearic acid. The general use and selection of such additives is well known to those skilled in the art.

Dried pellets and/or spray dried pellets may be combined with elastomer as described above using any dry mixing method known to those of skill in the art.

Alternatively or in addition, wet pellets may be combined with elastomer according to the teachings of one or more of US20220332016, WO2021247153, WO2022125679, WO2022125683, WO2022125677, and WO2022125675, the entire contents of all of which are incorporated herein by reference. For example, the wet pellets and elastomer in solid form may be charged into a mixer and mixed under conditions where temperatures are controlled to remove at least a portion of the water in the pellets via evaporation. The elastomer is optionally premasticated prior to introduction of the wet pellets. The wet filler may be added all at once or in aliquots.

Any suitable mixer, such as a Banbury or Brabender mixer or other internal or closed mixer, or an open mixer, or an extruder or a continuous compounder or a kneading mixer or a combination thereof, may be employed to combine wet pellets with elastomer. Other mixers include a kneading type internal mixer. Commercially available internal mixers from Farrel-Pomini, Harburg Freudenberger Maschinenbau GmbH (HF), Kobelco, or Pelmar Eng'r Ltd can be used. Besides the option to use inner circuits of steam or water or other fluid in the rotors, in addition or alternatively, the internal mixer can have cooling or heating jackets at one region or part or more than one region or part of the mixing chamber to control the temperature of the components being mixed therein. This can create one or more heating/cooling zones in a wall or portion of a wall of a mixer. The mixer can be a single stage mixer or a multi-stage mixer (e.g., two stages or more). Examples of mixers and designs that can be utilized are described in European Patent No. 2423253B1 and U.S. Pat. No. 7,556,419, the disclosures of which are incorporated herein by reference.

As another option, the mixer can be a continuous mixer. For example, the solid elastomer and wet filler may be mechanically worked by using one or more of a continuous internal mixer, a twin screw extruder, a single screw extruder, or a roll mill, such as those described in U.S. Pat. No. 9,855,686 B2, the disclosure of which is incorporated herein by reference. Suitable kneading and masticating devices are well known and commercially available, including for example, a Unimix Continuous Mixer and MVX (Mixing, Venting, eXtruding) Machine from Farrel Pomini Corporation of Ansonia, Conn., an FCM™ Farrel Continuous Mixer, a long continuous mixer from Pomini, Inc., a Pomini Continuous Mixer, twin rotor corotating intermeshing extruders, twin rotor counterrotating non-intermeshing extruders, continuous compounding extruders, the biaxial milling extruder produced by Kobe Steel, Ltd., and a Kobe Continuous Mixer. Alternative masticating apparatus suitable for use with one or more embodiments disclosed herein will be familiar to those of skill in the art.

The mixing can be performed with a mixer(s) having at least one rotor and the mixer can be one or more of the following: a kneader, a roll mill, a screw extruder, a twin-screw extruder, a multiple-screw extruder, a continuous compounder, and/or a twin-screw extruder. The mixing can be performed with a mixer(s) having at least one rotor and the mixer can have two-wing rotors, four-wing rotors, six-wing rotors, eight-wing rotors, and/or one or more screw rotors.

The mixing process to combine wet pellets with elastomer may be a one stage (single stage) or multi-stage (multi-step) process. In a multi-stage process, one or more mixers or mixer types may be employed. For stages where an internal mixer is used, the fill factor at each such stage may independently be no more than 72%, no more than 70%, or no more than 68%, or no more than 66%, such as from about 30% to 72%, from 40% to 70%, from 45% to 70%, from 30% to 60%, from 50 to 72%, from 50 to 70%, from 50 to 68%, from 60 to 72%, from 60 to 70%, from 60 to 68%, from 65 to 72%, from 65 to 70%, from 65 to 68%, or from 40 to 60% or from 50 to 60% and the like. The temperature of the mixer may be controlled to control the temperature of the mixture, the amount of water evaporated, or both. For example, in a multi-stage process, the temperature of the mixer for each stage may be controlled to control the amount of water evaporated from the mixture in the first mixing stage and in one or more subsequent stages. For instance, the liquid content of the composite discharged can be lower than the liquid content of the material charged into the mixer by an amount of from 10% to 99.9% (wt. % vs wt. %), from 10% to 95%, or from 10% to 50%. Alternatively or in addition, the rate of rate of liquid release from the composite or mixture during mixing, e.g., by evaporation, can be measured as a time average release rate of the liquid per kg of composite or mixture (e.g., total liquid removed/(release time x composite weight), and this rate can be from 0.01 to 0.14 kg/(min kg) or from 0.01 to 0.07 kg/(min-kg) or other rates below or above this range.

Alternatively or in addition, the mixing may be controlled in one or more stages to allow a predetermined total specific energy (energy applied to a mixing system that drives one or more rotors per mass of composite on a dry weight basis), e.g. from 1000 kJ/kg composite (or per kg mixture present in the mixer) to 10,000 kJ/kg composite (or per kg mixture present in the mixer), for example from 2,000 kJ/kg to 5,000 kJ or 1,500 kJ/kg to 8,000 kJ/kg, 1,500 kJ/kg to 7,000 kJ/kg, 1,500 kJ/kg to 6,000 kJ/kg, 1,500 kJ/kg to 5,000 kJ/kg, 1,500 kJ/kg to 3,000 kJ/kg, 1,600 kJ/kg to 8,000 kJ/kg, 1,600 kJ/kg to 7,000 kJ/kg, 1,600 kJ/kg to 6,000 kJ/kg, 1,600 kJ/kg to 5,000 kJ/kg, 1,600 kJ/kg to 4,000 kJ/kg, 1,600 kJ/kg to 3,000 kJ/kg, or other values in any of these ranges. Alternatively or in addition, the specific energy applied to the mixture may be divided to ensure a certain amount of specific energy is applied before or after a portion, e.g., 75% of the filler, is added to the mixer. That is, the filler need not be added all at once. Mixing times at each stage may be any suitable time, for example, from 1 min to 40 min, from 1 min to 20 min, from 1 min to 15 min, from 5 min to 30 min, from 5 min to 20 min, from 5 min to 15 min, or from 1 min to 12 min, from 1 min to 10 min, from 3 min to 30 min. or other times. Alternatively or in addition, the dump discharge temperature for each stage may be from 120° C. to 180° C., 120° C. to 190° C., 130° C. to 180° C., such as from 140° C. to 180° C., from 150° C. to 180° C., from 130° C. to 170° C., from 140° C. to 170° C., from 150° C. to 170° C., or other temperatures within or outside of these ranges.

Following any one or more mixing steps or stages, the resulting composite may be subjected to one or more post-processing steps, for example, to shape or form the composite and/or allow for improved handling. Post-processing may provide a composite that can be dried, homogenized, extruded, calendared, milled, granulated, cut, baled, or sheeted. The composite may be compounded and vulcanized immediately or may be held for a period of time prior to compounding. Suitable equipment for various post-processing steps include but are not limited to one or more of an internal mixer, a kneader, a roll mill, an open mill, a screw extruder, a twin-screw extruder, a multiple-screw extruder, a continuous compounder, and/or a twin screw discharge extruder fitted with a roller die (e.g., twin-screw sheeter) or fitted with stationary knives. Depending on which device or devices are used, it may be desirable to process the composite through the device more than one time or through a series of like or different devices having the same or different operating settings (e.g., speed, temperature, energy input, etc.). Alternatively or in addition, the elastomer composite may be combined with added filler, added elastomer, or both, prior to or as part of the vulcanization process. The additional filler may be the same or different as the particulate filler in the elastomer composite and may include any filler known to those of skill in the art, including the fillers listed as additional and supplemental fillers in this case and including additional wet milled reclaimed carbon. The added filler and or elastomer may increase or decrease the filler loading of the vulcanizate with respect to the elastomer composite.

To vulcanize the elastomer composite material, it is combined with a curative package including a cross-linking agent, any necessary activators and accelerators, anti-oxidant, and additional optional additives such as any of those listed above. Where sulfur is used as a cross-linking agent, typical activators include zinc oxide and or stearic acid, and typical accelerators include sulfenamides such as N-tert-butyl-2-benzothiazole sulfenamide (TBBS) and N-cyclohexyl-2-benzothiazole sulfonamide (CBS). Anti-oxidants include N-(1,3-dimethylbutyl)-N′-phenyl-p-phenylenediamine (6PPD) and those listed in WO2012/037244. Other curatives used in rubber processing are peroxides, urethane crosslinkers, metallic oxides, acetoxysilane compounds, and so forth. Additional suitable components for sulfur-based and other cross-linking systems and methods of mixing and vulcanizing elastomer composites are well known to those of skill in the art. For example, typical procedures used for rubber compounding are described in Maurice Morton, Rubber Technology, 3rd Edition, Van Norstrand Reinhold Company, New York 1987, and 2nd Edition, Van Nordstrand Reinhold Company, New York 1973.

A variety of rubber articles may incorporate the vulcanizate. For example, the vulcanizate may be incorporated in a tire, e.g., pneumatic tires, non-pneumatic tires, or solid tires. For example, the vulcanizate may be incorporated in tire treads, tire carcasses, undertread, innerliners, sidewalls, sidewall inserts, wire-skim, or cushion gum for retread tires. Alternatively or in addition, the vulcanizate may be incorporated in hoses, linings, liners, seals, gaskets, anti-vibration articles, tracks, track pads for track-propelled vehicle equipment, engine mounts, earthquake stabilizers, mining equipment screens, mining equipment linings, conveyor belts, chute liners, slurry pump liners, mud pump impellers, valve seats, valve bodies, piston hubs, piston rods, plungers, impellers for mixing slurries and slurry pump impellers, grinding mill liners, cyclones and hydrocyclones, expansion joints, linings for dredge pumps and outboard motor pumps for marine equipment, shaft seals for marine, oil, aerospace, and other applications, propeller shafts, or linings for pipes to convey, e.g., oil sands or tar sands. Alternatively or in addition, the vulcanizate may be incorporated into engine mounts, bushings, weather stripping, windshield wipers, automotive components, seals, gaskets, housings, and wheel or track elements.

The resulting vulcanizate may have fatigue properties, for example, cycles to failure, equivalent or no more than 10% less than vulcanizates produced via the same process and with the same composition except with ASTM N550 carbon black in place of the reclaimed carbon. Alternatively or in addition, the resulting vulcanizate may have fatigue properties equivalent to or greater than 90% of those for vulcanizates produced via the same process and with the same composition except with the reclaimed carbon substituted by an equal amount of the additional filler employed in the vulcanizate produced according to the invention.

The present invention includes the following aspects/embodiments/features in any order and/or in any combination:
1. A method to process reclaimed carbon, said method comprising media milling wet reclaimed carbon to obtain milled reclaimed carbon, wherein said media milling results in 10¹³-10¹⁴ media collisions per kg of dry milled reclaimed carbon, during said milling.
2. A method to process reclaimed carbon, said method comprising media milling wet reclaimed carbon to obtain milled reclaimed carbon, wherein the milling comprises media milling that expends a specific energy of 1 kWh/kg to 10 kWh/kg of dry milled reclaimed carbon.
3. A method to process reclaimed carbon, said method comprising media milling wet reclaimed carbon to obtain milled reclaimed carbon, wherein said media milling results in a volume weighted particle size distribution of the milled reclaimed carbon measured via disc centrifuge photosedimentometry with D50 of 250-400 nm, preferably 250-320 nm, and D90 of 350 to 1100 nm, for example, 500 to 1100 nm.
4. The method of any preceding or following embodiment/feature/aspect, wherein the specific energy expended during media milling is from 1 kWh/kg to 10 kWh/kg.
5. The method of any preceding or following embodiment/feature/aspect, wherein the specific energy expended during media milling is from 1 kWh/kg to 3.5 kWh/kg.
6. The method of any preceding or following embodiment/feature/aspect, wherein the specific energy is from 1.25 kWh/kg to 3.1 kWh/kg.
7. The method of any preceding or following embodiment/feature/aspect, wherein said media milling results in 10¹³-10¹⁴ media collisions per kg of dry milled reclaimed carbon, during said milling.
8. The method of any preceding or following embodiment/feature/aspect, wherein said media milling results in 2×10¹³-10¹⁴ media collisions per kg of dry milled reclaimed carbon, during said milling.
9. The method of any preceding or following embodiment/feature/aspect, wherein said media milling results in 3×10¹³-10¹⁴ media collisions per kg of dry milled reclaimed carbon, during said milling.
10. The method of any preceding or following embodiment/feature/aspect, wherein the media milling is agitated ball milling, planetary ball milling, or centrifugal ball milling.
11. The method of any preceding or following embodiment/feature/aspect, wherein the media milling is agitated ball milling.
12. The method of any preceding or following embodiment/feature/aspect, wherein the media milling utilizing a media that is solid balls having an average size that is from about 0.25 mm to 2 mm, for example, 0.25-1 mm, and a volume loading of from 50% to 98% in a mill.
13. The method of any preceding or following embodiment/feature/aspect, wherein a volume weighted particle size distribution of the media milled reclaimed carbon measured via disc centrifuge photosedimentometry has D50 of 250-400 nm, preferably 250-320 nm, and D90 of 350 to 1100 nm, for example, 500 to 1100 nm.
14. The method of any preceding or following embodiment/feature/aspect, wherein the milling is such that a rubber sample having 20 to 60 phr of the milled reclaimed carbon results in less than 10% or less than 5% undispersed area (dispergrader %).
15. The method of any preceding or following embodiment/feature/aspect, wherein the milling is such that a rubber sample having 20-80 phr of particulate filler, for example, 30-70 phr, 40 to 60 phr, or 45-55 phr of particulate filler, of which 10-40 wt % is media milled reclaimed carbon, e.g., 15-35 wt % or 20 to 30 wt %, has up to 3% undispersed area, for example, 1-3% undispersed area.
16. The method of any preceding or following embodiment/feature/aspect, wherein the milling is such that a rubber sample having 10 to 50 phr, for example, 10-40 phr, milled rC has an undispersed area UA satisfying UA≤3.35−(0.04*phr rC).
17. The method of any preceding or following embodiment/feature/aspect, wherein the milling is such that a rubber sample having 20 to 60 phr of the milled reclaimed carbon results in an abrasion volume loss that is no more than 10% greater or within 5% of a comparative rubber sample produced in the same manner but having N550 carbon black instead of the milled reclaimed carbon.
18. The method of any preceding or following embodiment/feature/aspect, wherein the milling is such that a rubber sample having 20 to 80 phr of particulate filler, for example, 30-70 phr, 40 to 60 phr, or 45-55 phr of particulate filler, of which 10-40 wt % is media milled reclaimed carbon, e.g., 15-35 wt % or 20 to 30 wt %, has an abrasion loss of 90 to 100 mm³, for example, 91-95 mm³, when measured according to ASTM D5963.
19. The method of any preceding or following embodiment/feature/aspect, wherein the particulate filler comprises virgin carbon black, for example, a carbon black having BET surface area from 35 to 110 m²/g, e.g., an N300 or N500 series carbon black, for example, N330 or N550 carbon black, for example, N330 carbon black.
20. The method of any preceding or following embodiment/feature/aspect, wherein the milling is such that a rubber sample having 20 to 60 phr of the milled reclaimed carbon results in a M300/M100 ratio that is either a) no more than 10% less or within 5% of a comparative rubber sample produced in the same manner but having N550 carbon black instead of the milled reclaimed carbon or b) 4.5 to 5.
21. The method of any preceding or following embodiment/feature/aspect, wherein the milling is such that a rubber sample having 20 to 60 phr of the milled reclaimed carbon results in a M300 (MPa) or maximum load (N) that is no more than 10% less or no more than 5% less of a comparative rubber sample produced in the same manner but having N550 carbon black instead of the milled reclaimed carbon.
22. The method of any preceding or following embodiment/feature/aspect, wherein particle size is measured according to PSD Method 1.
23. A milled reclaimed carbon produced by the method of any of any preceding or following embodiment/feature/aspect
24. Particulate filler comprising 10-40 wt % reclaimed carbon, wherein a volume weighted particle size distribution of the reclaimed carbon measured via disc centrifuge photosedimentometry has a D50 of 250-400 nm, preferably 250-320 nm, and D90 of 350 to 1100 nm, for example, 500 to 1100 nm.
25. The particulate filler of any preceding or following embodiment/feature/aspect, comprising 15 to 35 wt % reclaimed carbon or 20 to 30 wt % reclaimed carbon or 25 to 35 wt % reclaimed carbon.
26. The particulate filler of any preceding or following embodiment/feature/aspect, further comprising one or more of carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, and carbon black-coated particles.
27. The particulate filler of any preceding or following embodiment/feature/aspect, further comprising carbon black having an OAN of 85 to 120 mL/100 g, for example, 90 to 117 mL/100 g, 95 to 115 mL/100 g, 100 to 113 mL/100 g, or 105 to 115 mL/100g.
28. The particulate filler of any preceding or following embodiment/feature/aspect, further comprising carbon black.
29. The particulate filler of any preceding or following embodiment/feature/aspect, further comprising carbon black having a BET surface area from 35 to 110 m²/g, for example, 35-65 m²/g, 65-90 m²/g, or 90-110 m²/g.
30. The particulate filler of any preceding or following embodiment/feature/aspect, further comprising an N300 or N500 series carbon black, for example, N330 or N550 carbon black.
31. The particulate filler of any preceding or following embodiment/feature/aspect, wherein the particulate filler is in the form of pellets.
32. The particulate filler of any preceding or following embodiment/feature/aspect, wherein the pellets consist substantially of the particulate filler, optional water, and optional binder.
33. The particulate filler of any preceding or following embodiment/feature/aspect, wherein the particulate filler has a moisture content of 15 to 80%, for example, 40-60 wt %.
34. The particulate filler of any preceding or following embodiment/feature/aspect, wherein a rubber sample having 20 to 60 phr of the milled reclaimed carbon results in less than 10% or less than 5% undispersed area (dispergrader %).
35. The particulate filler of any preceding or following embodiment/feature/aspect, wherein a rubber sample having 20-80 phr of the particulate filler, for example, 30-70 phr, 40 to 60 phr, or 45-55 phr of the particulate filler, has up to 3% undispersed area, for example, 1-3% undispersed area.
36. The particulate filler of any preceding or following embodiment/feature/aspect, wherein a rubber sample having 10 to 50 phr, for example, 10-40 phr, of the reclaimed carbon has an undispersed area UA satisfying UA≤3.35−(0.04*phr rC).
37. The particulate filler of any preceding or following embodiment/feature/aspect, wherein a rubber sample having 20 to 60 phr of the reclaimed carbon results in an abrasion volume loss that is no more than 10% greater or within 5% of a comparative rubber sample produced in the same manner but having N550 carbon black instead of the reclaimed carbon.
38. The particulate filler of any preceding or following embodiment/feature/aspect, wherein a rubber sample having 20 to 80 phr of the particulate filler, for example, 30-70 phr, 40 to 60 phr, or 45-55 phr of particulate filler, has an abrasion loss of 90 to 100 mm³, for example, 91-95 mm³, when measured according to ASTM D5963.
39. The particulate filler of any preceding or following embodiment/feature/aspect, wherein a rubber sample having 20 to 60 phr of the reclaimed carbon results in a M300/M100 ratio that is either a) no more than 10% less or within 5% of a comparative rubber sample produced in the same manner but having N550 carbon black instead of the reclaimed carbon or b) 4.5 to 5.
40. The particulate filler of any preceding or following embodiment/feature/aspect, wherein a rubber sample having 20 to 60 phr of the reclaimed carbon results in a M300 (MPa) or maximum load (N) that is no more than 10% less or no more than 5% less of a comparative rubber sample produced in the same manner but having N550 carbon black instead of the reclaimed carbon.
41. The particulate filler of any preceding or following embodiment/feature/aspect, wherein particle size is measured according to PSD Method 1.
42. A pellet comprising the particulate filler of any preceding or following embodiment/feature/aspect, the particulate filler further comprising at least one additional filler selected from carbon black, silicon treated carbon black, silica coated carbon black, carbon black-coated particles, and precipitated silica.
43. An elastomer composite comprising the particulate filler of any preceding or following embodiment/feature/aspect and at least one elastomer, and optionally further comprising one or more of carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, and carbon black-coated particles.
44. The elastomer composite of any preceding or following embodiment/feature/aspect, wherein the elastomer is selected from natural rubbers, functionalized natural rubbers, styrene-butadiene rubbers, functionalized styrene-butadiene rubbers, polybutadiene rubbers, functionalized polybutadiene rubbers, polyisoprene rubbers, ethylene-propylene copolymers, isobutylene-based rubbers, polychloroprene rubbers, nitrile rubbers, hydrogenated nitrile rubbers, polysulfide rubbers, polyacrylate elastomers, fluoroelastomers, perfluoroelastomers, and blends thereof.
45. The elastomer composite of any preceding or following embodiment/feature/aspect, wherein the elastomer composite is a vulcanized elastomer composite.
46. The elastomer composite of any preceding or following embodiment/feature/aspect, having a dispersion no greater than 4% undispersed area, for example, no greater than 3% undispersed area or from 1% to 3% undispersed area.
47. The elastomer composite of any preceding or following embodiment/feature/aspect, wherein the elastomer composite has 20-60 phr of particulate filler and less than 10% or less than 5% undispersed area (Dispergrader %).
48. The elastomer composite of any preceding or following embodiment/feature/aspect, wherein the elastomer composite has 20-80 phr of particulate filler, for example, 30-70 phr, 40 to 60 phr, or 45-55 phr of particulate filler, and up to 3% undispersed area, for example, 1-3% undispersed area (Dispergrader %).
49. The elastomer composite of any preceding or following embodiment/feature/aspect, wherein the elastomer composite has 10-40 phr, for example, 10-40 phr, media milled rC and an undispersed area UA satisfying UA≤3.35−(0.04*phr rC).
50. The elastomer composite of any preceding or following embodiment/feature/aspect, wherein the elastomer composite has 20-60 phr of the reclaimed carbon and an abrasion volume loss that is no more than 10% greater or within 5% of a comparative rubber sample having N550 carbon black instead of the milled reclaimed carbon.
51. The elastomer composite of any preceding or following embodiment/feature/aspect, wherein the elastomer composite has 20 to 80 phr of particulate filler, for example, 30-70 phr, 40 to 60 phr, or 45-55 phr of particulate filler, and an abrasion loss of 90 to 100 mm³, for example, 91-95 mm³, when measured according to ASTM D5963.
52. The elastomer composite of any preceding or following embodiment/feature/aspect, wherein the elastomer composite has 20 to 60 phr of the reclaimed carbon and a M300/M100 ratio that is either a) no more than 10% less or within 5% of a comparative rubber sample having N550 carbon black instead of the milled reclaimed carbon or b) 4.5 to 5.
53. The elastomer composite of any preceding or following embodiment/feature/aspect, wherein the elastomer composite has 20 to 60 phr of the reclaimed carbon and a M300 (MPa) or maximum load (N) that is no more than 10% less or no more than 5% less of a comparative rubber sample having N550 carbon black instead of the milled reclaimed carbon
54. A tire tread comprising a vulcanizate of a mixture comprising the elastomer composite of any of any preceding or following embodiment/feature/aspect and a curative package.
55. An article comprising a vulcanizate of a mixture comprising the elastomer composite of any of any preceding or following embodiment/feature/aspect and a curative package.
56. The article of any preceding or following embodiment/feature/aspect, wherein the article is incorporated in pneumatic tires, non-pneumatic tires, or solid tires.
57. The article of any preceding or following embodiment/feature/aspect, wherein the article is selected from tire treads, undertread, innerliners, sidewalls, sidewall inserts, wire-skim, and cushion gum for retread tires.
58. The article of any preceding or following embodiment/feature/aspect, wherein the article is selected from hoses, linings, liners, seals, gaskets, anti-vibration articles, tracks, track pads for track-propelled vehicle equipment, engine mounts, earthquake stabilizers, mining equipment screens, mining equipment linings, conveyor belts, chute liners, slurry pump liners, mud pump impellers, valve seats, valve bodies, piston hubs, piston rods, plungers, impellers for mixing slurries and slurry pump impellers, grinding mill liners, cyclones and hydrocyclones, expansion joints, linings for dredge pumps and outboard motor pumps for marine equipment, shaft seals for marine, oil, aerospace, and other applications, propeller shafts, pipe linings, engine mounts, bushings, weather stripping, windshield wipers, automotive components, seals, gaskets, housings, wheel elements, and track elements.

The present invention will be further clarified by the following examples which are intended to be only exemplary in nature EXAMPLES

### Example 1

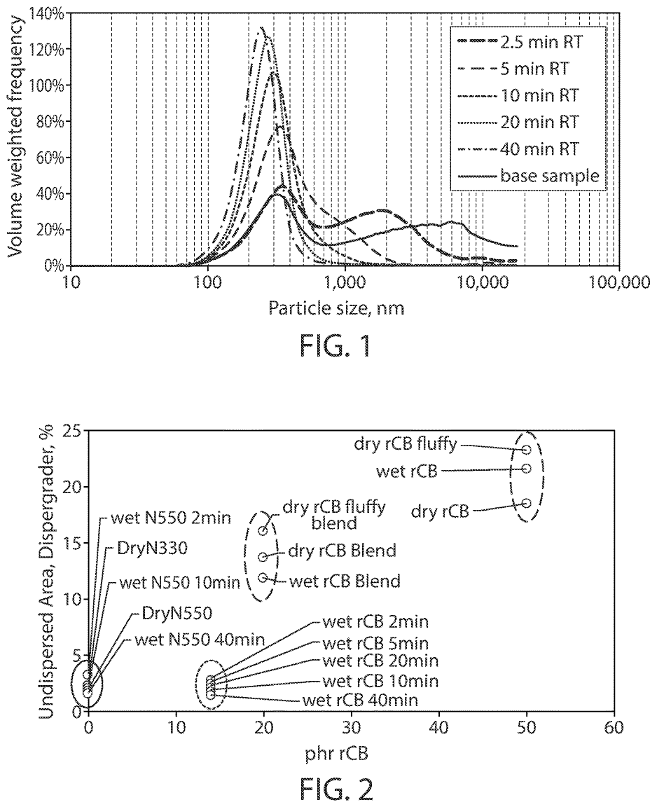

N550 and N330 CB pellets were jet milled in a 4 inch (10.2 cm) Micron Master Jet Pulverizer SN 1634 Model 04-626 with a flow rate of about 2 kg/hr and a top pressure of 80 psi (0.55 MPa) and a bottom pressure of 40 psi (0.03 MPa) to produce a fluffy material. rC was obtained in fluffy form from a commercial supplier, with a reported D50 of 2 μm. The measured PSD of this material is given in FIG. 1 and FIG. 6. All materials were dispersed in water at 14 wt. % to form a slurry for milling. The wet milling was carried out in recirculating batch mode on a MiniCer media mill (Netzsch) using 0.5 mm YSZ beads with 85% fill factor and 4200 rpm. The “residence time” was calculated using the equation “residence time”=“batch time” *“mill volume”/“batch volume”, where “batch time” is the total run time of a batch, the “mill volume” is the volume of the grinding chamber minus the volume occupied by the media, and the “batch volume” is the total volume of the batch being milled.

The milled slurry, containing 86 wt % water, was stirred on a hot plate set to 80° C. until the moisture content reached 70 wt %. The batch was then pelletized by combining with fluffy N550 in 4:6 proportion by weight in a pelletizer (Feeco Inc.) operated at 900 rpm so that the total water content became 50% by weight, allowing pellet formation. Pellets were either dried in an oven at 80° C. or kept wet until mixing, depending on the mixing method.

To characterize the particle size obtained in the slurry, milled rC slurry (14 wt. % solid) was diluted to 2000 ppm by DI water containing 600 ppm Triton X100 surfactant. The diluted solution was then mixed by a DISPERMAT LC55 mixer equipped with a lightweight 30 mm diameter 18 tooth impeller at 800 RPM for 5 minutes. Then the solution was stirred using a magnetic stir bar on a stir plate for 24 hours. The sample solution was then further diluted to 400 ppm using DI water containing 400 ppm Triton X100 surfactant and left to rotate in a 40 ml vial on a roller until measurement.

Disc centrifuge (DC24000, CPS Instruments) measurements were carried out at 5000 RPM. First, 24%, 22%, 20%, 18%, 16%, 14%, 12%, 10%, 8% of sucrose solution in DI water was injected sequentially into the disc (1.6 ml for each), then 1 ml dodecane was injected to seal the gradient. The gradient was given 1 hour to stabilize before measurements. In the particle size measurements, sample density and refractive index was set as 1.86 g/cm³ and n=1.84+0.846i. The results represent the equivalent sedimentation result of a spherical particle with a density of 1.86 g/cm³ and a refractive index of n=1.84+0.846i. All measurements were stopped immediately after the signal touched the baseline.

The changes in particle size are shown in FIG. 1 and FIG. 6. The starting material particle distribution had a D90 of 9 μm. After a residence time of 2.5 min, the D90 decreased to 3 μm, and continued to decrease until reaching 0.34 m at 40 min.

To determine what residence time was sufficient for appropriate rubber properties, the milled materials were tested in SBR composite. The details of each example including the formulation and mixing protocol are provided in Table 2 below.

TABLE 2

| | Comparative | Comparative | Comparative | | Comparative | | |
|---|---|---|---|---|---|---|---|
| Comparative | Example | Example | Example | Comparative | Example 6 | | Comparative |
| Example 1 | 2 | 3 | 4 | Example 5 | dry rC | Comparative | Example 8 |
| DryN5 | DryN3 | dry | dry rC | dry rC | fluffy | Example 7 | wet rC |
| 50 | 30 | rCB | Blend | fluffy | blend | wet rC | Blend |

Stage 1

| | | | | | | | | |
|---|---|---|---|---|---|---|---|---|
| Kralex SBR 1502 | 100 | 100 | 100 | 100 | 100 | 100 | 100 | 100 |
| N550 | 47.5 | | | | | 30 | | |
| N330 | | 50 | | | | | | |
| rC, pellets | | | 50 | | | | | |
| Co-pellet 4:6 rC:N550 | | | | 50 | | | | |
| rC, fluffy | | | | | 53 | 20 | | |
| rC, pellets, 50% H2O | | | | | | | 50 | |
| Co-pellet 4:6 rC:N550, | | | | | | | | 50 |
| 50% H2O | | | | | | | | |
| N550, 2 min, pellet, | | | | | | | | |
| 50% H2O | | | | | | | | |
| N550, 2 min, pellet, | | | | | | | | |
| 50% H2O | | | | | | | | |
| N550, 2 min, pellet, | | | | | | | | |
| 50% H2O | | | | | | | | |
| rC, 2 min, co-pellet | | | | | | | | |
| 4:6 rC:N550, 50% H2O | | | | | | | | |
| rC, 5 min, co-pellet | | | | | | | | |
| 4:6 rC:N550, 50% H2O | | | | | | | | |
| rC, 10 min, co-pellet | | | | | | | | |
| 4:6 rC:N550, 50% H2O | | | | | | | | |
| rC, 20 min, co-pellet | | | | | | | | |
| 4:6 rC:N550, 50% H2O | | | | | | | | |
| rC, 40 min, co-pellet | | | | | | | | |
| 4:6 rC:N550, 50% H2O | | | | | | | | |
| Stearic Acid | 2 | 2 | 2 | 2 | 2 | 2 | | |
| Zinc Oxide | 3 | 3 | 3 | 3 | 3 | 3 | | |
| Wax | 1 | 1 | 1 | 1 | 1 | 1 | | |
| Antioxidant DQ | 1.5 | 1.5 | 1.5 | 1.5 | 1.5 | 1.5 | | |
| Stangard 6PPD | 3 | 3 | 3 | 3 | 3 | 3 | 2 | 2 |

Stage 2

| | | | | | | | | |
|---|---|---|---|---|---|---|---|---|
| Sulfur | 1.5 | 1.5 | 1.5 | 1.5 | 1.5 | 1.5 | | |
| BBTS | 1.5 | 1.5 | 1.5 | 1.5 | 1.5 | 1.5 | | |
| Stearic Acid | | | | | | | 2 | 2 |
| Zinc Oxide RGT-M | | | | | | | 3 | 3 |
| Wax | | | | | | | 1.5 | 1.5 |
| Antioxidant DQ | | | | | | | 1.5 | 1.5 |
| Stangard 6PPD | | | | | | | 0.5 | 0.5 |

Stage 3

| | | |
|---|---|---|
| Sulfur | | 1.5 |
| BBTS | 1.5 | 1.5 |

Compound Properties

| | | | | | | | | |
|---|---|---|---|---|---|---|---|---|
| rC concentration, phr | 0 | 0 | 50 | 20 | 50 | 20 | 50 | 20 |
| Undispersed Area: | 1.6 | 2.3 | 18.5 | 13.8 | 23.2 | 16.1 | 21.5 | 12.0 |
| Dispergrader (%) | | | | | | | | |
| Stress at 300% strain | 13.3 | 13.1 | 10.2 | 11.6 | 8.7 | 11.0 | 8.2 | 10.7 |
| (MPa) | | | | | | | | |
| 300%/100% Stress | 4.22 | 4.68 | 3.85 | 4.17 | 3.44 | 3.92 | 3.67 | 4.14 |
| ratio | | | | | | | | |
| Abrasion volume Loss | 137 | 127 | 154 | 146 | 177 | 154 | 168 | 154 |
| (mm³) | | | | | | | | |

| | | | Comparative | | | | | |
|---|---|---|---|---|---|---|---|---|
| | Comparative | Comparative | Example | | | | | |
| | Example 9 | Example 10 | 11 | Example | Example | Example | Example | Example |
| | wet | wet | wet | 1 | 2 | 3 | 4 | 5 |
| | N550 | N550 | N550 | wet rC | wet rC | wet rC | wet rC | wet rC |
| | 2 min | 10 min | 40 min | 2 min | 5 min | 10 min | 20 min | 40 min |
| Stage 1 | | | | | | | | |
| Kralex SBR 1502 | 100 | 100 | 100 | 100 | 100 | 100 | 100 | 100 |
| N550 | 15 | 15 | 15 | 15 | 15 | 15 | 15 | 15 |
| N330 | | | | | | | | |
| rC, pellets | | | | | | | | |
| Co-pellet 4:6 rC:N550 | | | | | | | | |
| rC, fluffy | | | | | | | | |
| rC, pellets, 50% H2O | | | | | | | | |
| Co-pellet 4:6 rC:N550, | | | | | | | | |
| 50% H2O | | | | | | | | |
| N550, 2 min, pellet, | 35 | | | | | | | |
| 50% H2O | | | | | | | | |
| N550, 2 min, pellet, | | 35 | | | | | | |
| 50% H2O | | | | | | | | |
| N550, 2 min, pellet, | | | 35 | | | | | |
| 50% H2O | | | | | | | | |
| rC, 2 min, co-pellet | | | | 35 | | | | |
| 4:6 rC:N550, 50% H2O | | | | | | | | |
| rC, 5 min, co-pellet | | | | | 35 | | | |
| 4:6 rC:N550, 50% H2O | | | | | | | | |
| rC, 10 min, co-pellet | | | | | | 35 | | |
| 4:6 rC:N550, 50% H2O | | | | | | | | |
| rC, 20 min, co-pellet | | | | | | | 35 | |
| 4:6 rC:N550, 50% H2O | | | | | | | | |
| rC, 40 min, co-pellet | | | | | | | | 35 |
| 4:6 rC:N550, 50% H2O | | | | | | | | |
| Stearic Acid | | | | | | | | |
| Zinc Oxide | | | | | | | | |
| Wax | | | | | | | | |
| Antioxidant DQ | | | | | | | | |
| Stangard 6PPD | 2 | 2 | 2 | 2 | 2 | 2 | 2 | 2 |
| Stage 2 | | | | | | | | |
| Sulfur | | | | | | | | |
| BBTS | | | | | | | | |
| Stearic Acid | 2 | 2 | 2 | 2 | 2 | 2 | 2 | 2 |
| Zinc Oxide RGT-M | 3 | 3 | 3 | 3 | 3 | 3 | 3 | 3 |
| Wax | 1.5 | 1.5 | 1.5 | 1.5 | 1.5 | 1.5 | 1.5 | 1.5 |
| Antioxidant DQ | 1.5 | 1.5 | 1.5 | 1.5 | 1.5 | 1.5 | 1.5 | 1.5 |
| Stangard 6PPD | 0.5 | 0.5 | 0.5 | 0.5 | 0.5 | 0.5 | 0.5 | 0.5 |
| Stage 3 | | | | | | | | |
| Sulfur | 1.5 | 1.5 | 1.5 | 1.5 | 1.5 | 1.5 | 1.5 | 1.5 |
| BBTS | 1.5 | 1.5 | 1.5 | 1.5 | 1.5 | 1.5 | 1.5 | 1.5 |
| Compound Properties | | | | | | | | |
| rC concentration, phr | 0 | 0 | 0 | 14 | 14 | 14 | 14 | 14 |
| Undispersed Area: | 3.4 | 2.0 | 1.7 | 2.8 | 2.4 | 1.8 | 2.0 | 1.5 |
| Dispergrader (%) | | | | | | | | |
| Stress at 300% strain | 12.3 | 13.6 | 13.0 | 12.1 | 13.0 | 12.3 | 12.4 | 12.4 |
| (MPa) | | | | | | | | |
| 300%/100% Stress | 4.71 | 4.64 | 4.83 | 4.70 | 4.68 | 4.79 | 4.95 | 4.76 |
| ratio | | | | | | | | |
| Abrasion volume Loss | 138 | 137 | 136 | 140 | 138 | 138 | 130 | 138 |
| (mm³) | | | | | | | | |

The formulations for the experiments are given in Table 2. In the experiments, with the data results set forth in TABLE 2 and FIG. 2-5, the symbols/wording in the Table and Figures mean the following:
Dry N330=N330 carbon black, no rC present; pelletized and dried before mixing.
Wet N550 X min=N550, media milled with X indicating the milling residence time—e.g., “wet rC 20 min” means N550 media milled for 20 minutes residence time and then co-pelletized with fluffy N550 at mass ratio 4:6; not dried before mixing.
Dry N550=N550 carbon black, no rC present; pelletized and dried before mixing.
Wet rC X min=rC, media milled per the present invention with X indicating the milling residence time—e.g., “wet rC 20 min” means rC media milled for 20 minutes and then co-pelletized with fluffy N550 at a mass ratio of 4:6; not dried before mixing.
Dry rC Blend=4:6 parts by mass of rC and N550, co-pelletized and dried before mixing.
Wet rC Blend=4:6 parts by mass of rC and N550, co-pelletized and not dried before mixing.
Dry rC fluffy blend=un-pelletized rC and N550 mixed in the normal dry manner.
Dry rC=rC that is not media milled but pelletized and dried
Wet rC=rC that is not media milled but pelletized and not dried
Dry rC fluffy=rC that is not media milled, not pelletized and mixed in the normal dry manner.
   For the “not dried” samples, the amount of wetting was such that the water content was 50% by weight.

In addition to media milled rC samples, the option of introducing the rC as a fluffy material as well as wet mixing of rC wet pellets and co-pellets were evaluated. FIG. 2 shows the quality of dispersion in the obtained mixes. The dry, fluffy and wet process all produced rC mixes with worse dispersion than the control samples (long-dashed circles), while the media milled samples (short-dashed circle) had comparable dispersion to the carbon black control samples (solid circle).

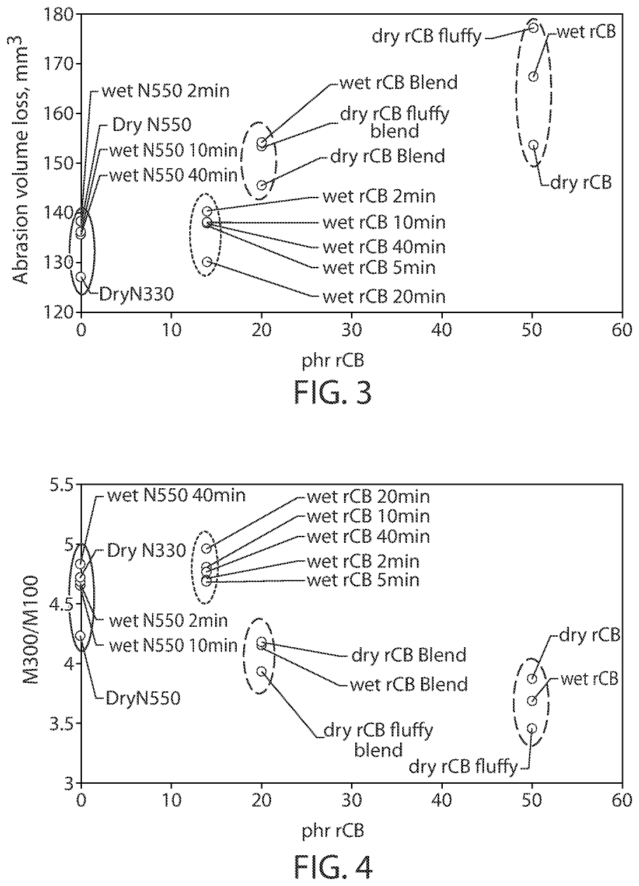

The experiments also showed an improvement in rubber performance. FIG. 3 shows the DIN abrasion volume loss. The media milled materials (short-dashed circle) showed comparable volume loss to the Wet N550 2 min control (solid circle), while other rC methods (long-dashed circles) showed performance degradation compared to the control. 40 minutes of residence time showed a degradation, possibly due to rC structure degradation, as seen in material softening, which can negatively affect DIN abrasion.

The slope of the tensile curve of a rubber compound, called reinforcement, is important for abrasion performance. In FIG. 4 the ratio of stress at 300 to 100%, M300/M100, was plotted to quantify reinforcement. As shown in the experiments, wet mixing caused N550 to become more reinforcing, comparable to dry mixed N330. Increasing rC content resulted in a decrease in reinforcement when mixed using the dry, wet, or fluffy methods. However, the media milled rC of the present invention did not show the decrease.

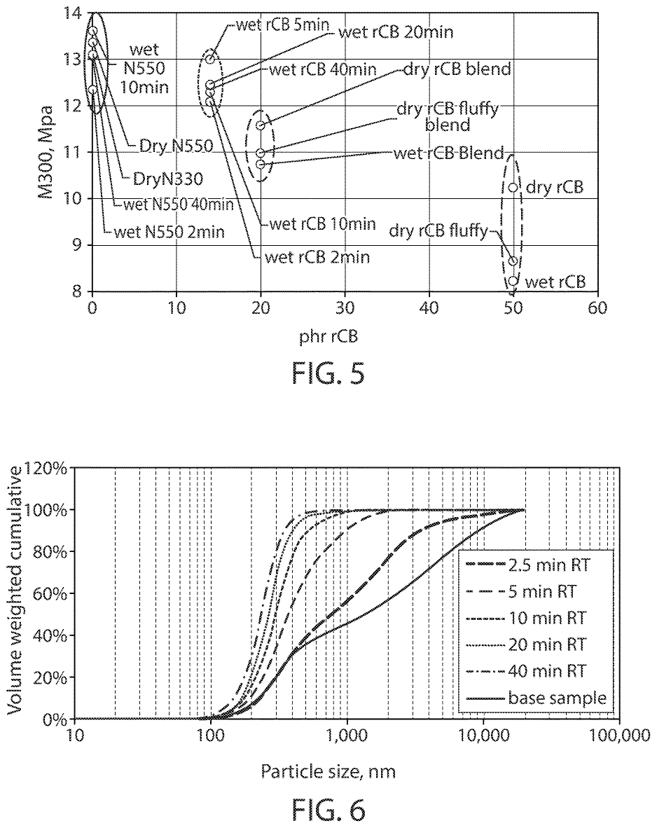

rC often results in inferior rigidity compared to CB mixes. rC incorporated using the fluffy, dry or wet methods produced the expected decrease in stress at 300% elongation (M300), as seen in FIG. 5. But, in the experiments conducted for the present invention, no degradation was observed.

While one optimal milling time for reinforcement and abrasion for these experiments was 20 minutes, the optimal milling time for low strain rigidity was 5 minutes, as seen in FIG. 5. This may be due to breakdown of agglomerates up to five minutes, and subsequent degradation of aggregate structure after five minutes.

Based on these observations, the use of media milling to process rC before producing composites makes significantly higher rC content possible. Since there is little or no degradation of properties compared to N550 compounds prepared by wet mixing, composites with up to 100% replacement may be possible.

TABLE 3 below provide a summary of some of the results achieved by the present invention, and normalized to the “wet N550 2 min” control, described in the above Example. These normalized results were used to derive equations describing the performance with and without the application of the present invention.

TABLE 3
Normalized vs N550 control of same mixing process

| | | | Comparative | | | | | |
|---|---|---|---|---|---|---|---|---|
| | Comparative | Comparative | Example | | | | | |
| | Example | Example | 9 | Example | Example | Example | Example | Example |
| | 7 | 8 | wet | 1 | 2 | 3 | 4 | 5 |
| | wet | wet rC | N550 | wet rC | wet rC | wet rC | wet rC | wet rC |
| | rC | Blend | 2 min | 2 min | 5 min | 10 min | 20 min | 40 min |
| rC | 50 | 20 | 0 | 14 | 14 | 14 | 14 | 14 |
| concentration | | | | | | | | |
| Undispersed | 643 | 357 | 100 | 84 | 72 | 54 | 60 | 45 |
| Area: | | | | | | | | |
| Dispergrader | | | | | | | | |
| (%) | | | | | | | | |
| 300% Mod. | 67 | 87 | 100 | 98 | 105 | 100 | 101 | 101 |
| (MPa) | | | | | | | | |
| 300%/100% | 78 | 88 | 100 | 100 | 99 | 102 | 105 | 101 |
| Modulus | | | | | | | | |
| Volume Loss | 121 | 111 | 100 | 101 | 100 | 100 | 94 | 100 |
| (mm³) | | | | | | | | |

Rubber mixing: Rubber composites were prepared using the formulation given in TABLE 2. The SBR used was or Kralex SBR 1502 styrene butadiene rubber (Synthos); the N550 was Spheron SO (Cabot Corp.); the N330 was Vulcan 3 (Cabot Corp.); the un-pelletized jet milled rC was Carbon Green 6 (CBp Cyprus Ltd., Limassol, Cyprus), in some instances pelletized as indicated in TABLE 2; stearic acid, rubber grade (Akrochem Corp.); zinc oxide was RGT-M (Akrochem Corp.); the wax was AKROWAX™ 5031 (Akrochem Corp.); antioxidant was DQ (Akrochem Corp.); 6PPD was Stangard 6PPD (Harwick Standard); sulfur was Rubbermakers Sulfur (Akrochem Corp); BBTS was Accelerator BBTS (Akrochem Corp.) All compositions were mixed in a 1.6 L Banbury mixer with two wing rotors. Dry mixed samples (pellet moisture<1 wt %) were prepared in two stages as described in TABLE 4. Wet mixed samples (pellet moisture>1 wt %) were prepared in three stages as described in TABLE 5. Regardless of which method was used, after each compounding stage, the compounds were sheeted on a 2-roll mill operated at 50° C. and about 22 rpm, followed by banding for 60 seconds and six pass-throughs with a nip gap about 5 mm, with a rest time before next stage of mixing (or curing, after the last stage) of at least 3 hours. Curing was performed in a heated press (150° C., 2500 lbs), for a time T90+40% of T90 as determined by a conventional rubber rheometer, where 190 is the time to achieve 900% vulcanization.

TABLE 4
Dry mix Protocols - Stage 1

| | |
|---|---|
| Fill Factor, % | 70 |
| Rotor Speed, rpm | 80 |
| Start Temperature, ° C. | 80 |

| Time (s) | Description |
|---|---|
| 0 | Add Polymer |
| 60 | Add ¾ Filler |
| 120 | Add remaining filler |
| 180 | Scrape/Sweep, add pre-blended chemicals |
| 240 | Scrape/Sweep |
| 300 | Dump, adjust RPM to stay <160° C. |

Stage 2

| | |
|---|---|
| Fill Factor, % | 65 |
| Rotor Speed, rpm | 60 |
| Start Temperature, ° C. | 52 |

| Time (s) | Description |
|---|---|
| 0 | Add previous stage batch and curatives |
| 30 | Scrape/Sweep |
| 90 | Dump - Adjust RPM to stay <150° C. |

TABLE 5
Wet mix Protocols - Stage 1

| | |
|---|---|
| Fill Factor, % | 70 |
| Rotor Speed, rpm | 100 |
| Start Temperature, ° C. | 90 |

| Time (s) | Description |
|---|---|
| 0 | Add Polymer and ¾ of filler |
| 150 | Add remaining filler, mix until 150° C. |
| time @ 150° C. | add 6PPD, reduce RPM to 80, mix until |
| | 155° C. |
| time @ 155° C. | Scrape/Sweep, mix until 160° C. |
| time @ 160° C. | Dump |

Stage 2

| | |
|---|---|
| Fill Factor, % | 68 |
| Rotor Speed, rpm | 80 |
| Start Temperature, ° C. | 52 |

| Time (s) | Description |
|---|---|
| 0 | Add Stage 1 compound |
| 30 | Add chemicals |
| 90 | Scrape/Sweep |
| 180 | Dump - adjust RPM to stay <150° C. |

Stage 3

| | |
|---|---|
| Fill Factor, % | 65 |
| Rotor Speed, rpm | 60 |
| Start Temperature, ° C. | 50 |

| Time (s) | Description |
|---|---|
| 0 | Add ½ masterbatch, curatives and ½ |
| | masterbatch. |
| 30 | Scrape/Sweep |
| 90 | Dump - Adjust rotor speed to not exceed |
| | 115° C. |

The following tests were used to obtain performance data on each of the vulcanizates. Tensile stress at 100% elongation (M100) and tensile stress at 300% elongation (M300) were evaluated by ASTM D412 (Test Method A, Type C) at 23° C., 50% relative humidity and at crosshead speed of 500 mm/min. Extensometers were used to measure tensile strain. The ratio of M300/M100 is referred to as tensile stress ratio (or reinforcement ratio). The cured rubber sample was sectioned using a razor blade fixed in a manual cutting jig for dispersion analysis. The sample was mounted and imaged on a Dispergrader instrument (Alpha Technologies). The following settings were used: “filler volume fraction”, 20%; “exposure time”, 40 ms; “color channel for analysis”, “blue”; “threshold for dispersion calculation”, 23 m; nodge to agglomerate fraction, 1; white area threshold, 0. The quantity reported by the Alpha Technologies instrument as “White Area, %” was interpreted as “undispersed area”. DIN Abrasion was evaluated according to the standard ASTM D5963 Rotating Method.

### Example 2

N330 CB pellets (Cabot Corporation) were jet milled to produce a fluffy material as described in Example 1. rC pellets (Reoil-RCB, REOIL S.P. Z O.O.) were jet-milled; the resulting material had D50 of 488 nm and D90 of 3430 nm when measured as described below. The jet-milled rC material was dispersed in water at 14 wt. % to form a slurry for milling. The wet milling was carried out in a pass-through fashion (single pass unless noted otherwise) on a Netzsch MiniCer wet media mill using 0.5 mm yttria-stabilized zirconia beads (YSZ, 3000 rpm or 4600 rpm) or 0.4-0.6 mm polystyrene beads (4600 rpm only) with a residence time and other settings noted in TABLE 6 below. The number of collisions is the same for polystyrene beads; however, the energy imparted during media milling with PS beads is 0.5× that imparted during media milling with YSZ beads.

TABLE 6A

| Target Residence | Batch time | Pass through flow rate | |
|---|---|---|---|
| Time (min) | (min) | (cc/min) | Pump setting |
| 0.1 | 0.58 | 690 | 298 |
| 0.2 | 1.16 | 345 | 149 |
| 0.5 | 2.90 | 138 | 60 |
| 1 | 5.80 | 69 | 30 |
| 2 | 11.59 | 34.5 | 15 |
| 4 | 22 | 52 (run | 15 (run |
| | | through twice) | through twice) |

TABLE 6B

| | 4600 rpm (YSZ) | | 3600 rpm (YSZ) | |
|---|---|---|---|---|
| min | kWh/kg | collisions per kg | kWh/kg | collisions per kg |
| 0.1 | 0.15 | 1.1E+12 | 0.10 | 7.6E+11 |
| 0.2 | 0.30 | 2.3E+12 | 0.20 | 1.5E+12 |
| 0.5 | 0.75 | 5.7E+12 | 0.49 | 3.8E+12 |
| 1 | 1.51 | 1.1E+13 | 0.98 | 7.6E+12 |
| 2 | 3.02 | 2.3E+13 | 1.96 | 1.5E+13 |
| 4 | 6.03 | 4.5E+13 | 3.92 | 3E+13 |

To characterize the particle size obtained in the slurry, milled rC slurry was diluted to 2000 ppm by DI water containing 600 ppm Triton X100 surfactant. The diluted solution was then mixed by a DISPERMAT LC55 mixer equipped with a lightweight 30 mm diameter 18 tooth impeller at 800 RPM for 5 minutes. Then the solution was stirred using a magnetic stir bar on a stir plate for 24 hours. The sample solution was then further diluted to 400 ppm using DI water containing 400 ppm Triton X100 surfactant and left to rotate in a 40 ml vial on a roller until measurement.

Disc centrifuge (DC24000, CPS Instruments) measurements were carried out at 5000 RPM. First, 24%, 22%, 20%, 18%, 16%, 14%, 12%, 8% of sucrose solution in DI water was injected sequentially into the disc (1.6 ml for each), then 1 ml dodecane was injected to seal the gradient. The gradient was given 1 hour to stabilize before measurements. In the disc centrifuge measurements, sample density and refractive index was set as 1.86 g/cm³ and n=1.84+0.846i. The results represent the equivalent sedimentation result of a spherical particle with a density of 1.86 g/cm³ and a refractive index of n=1.84+0.846i. All measurements were stopped immediately after the signal touched the baseline. D50 and D90 for the various samples are shown in TABLE 7 below.

TABLE 7

| Milling Speed/ | Residence | | |
|---|---|---|---|
| bead composition | time (min) | D50 (nm) | D90 (nm) |
| 4600 rpm (YSZ) | 0.1 | 350 | 2016 |
| | 0.2 | 313 | 1531 |
| | 0.5 | 284 | 1194 |
| | 1 | 272 | 858 |
| | 2 | 242 | 500 |
| | 4 | 223 | 379 |
| 3000 rpm (YSZ) | 0.1 | 238 | 1156 |
| | 0.2 | 334 | 1532 |
| | 0.5 | 321 | 1273 |
| | 1 | 320 | 921 |
| | 2 | 287 | 757 |
| | 4 | 247 | 432 |
| 4600 rpm | 0.1 | 378 | 2161 |
| (polystyrene) | 0.2 | 322 | 1631 |
| | 0.5 | 300 | 1049 |
| | 1 | 275 | 727 |
| | 2 | 265 | 492 |
| | 4 | 262 | 531 |

The milled slurry, containing 86 wt % water, was centrifuged using a Thermo Scientific Sorvall Legend XTR centrifuge for 15 minutes to obtain centrifuge cake which was approximately 70% solids. Each batch was then pelletized by combining the appropriate amount of centrifuge cake and slurry with fluffy N330 carbon black in a rotary pin pelletizer operated at 900 rpm with walls heated to 50 deg C. to form a blend with 30% rC and 70% N330 carbon black by weight. Pellets were dried in an oven at 80° C.

SBR composites were prepared with 50 phr (total) rC and carbon black using the mixing protocol of Table 4 and the vulcanization procedure described in Example 1 with the formulation described in TABLE 8 below (chemicals as described in Example 1). Rubber properties were measured as described in Example 1.

TABLE 8

| Component | Amount (phr) |
|---|---|
| SBR | 100 |
| Stearic Acid | 2 |
| Zinc Oxide | 3 |
| Wax | 1 |
| Antioxidant | 1.5 |
| 6PPD | 3 |
| Sulfur | 1.5 |
| BBTS | 1.5 |

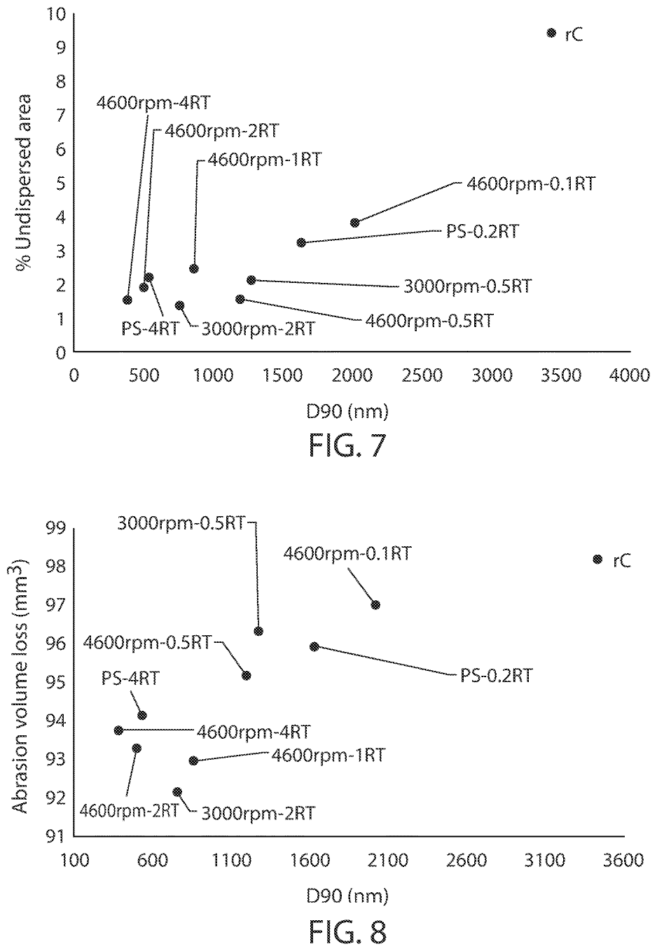

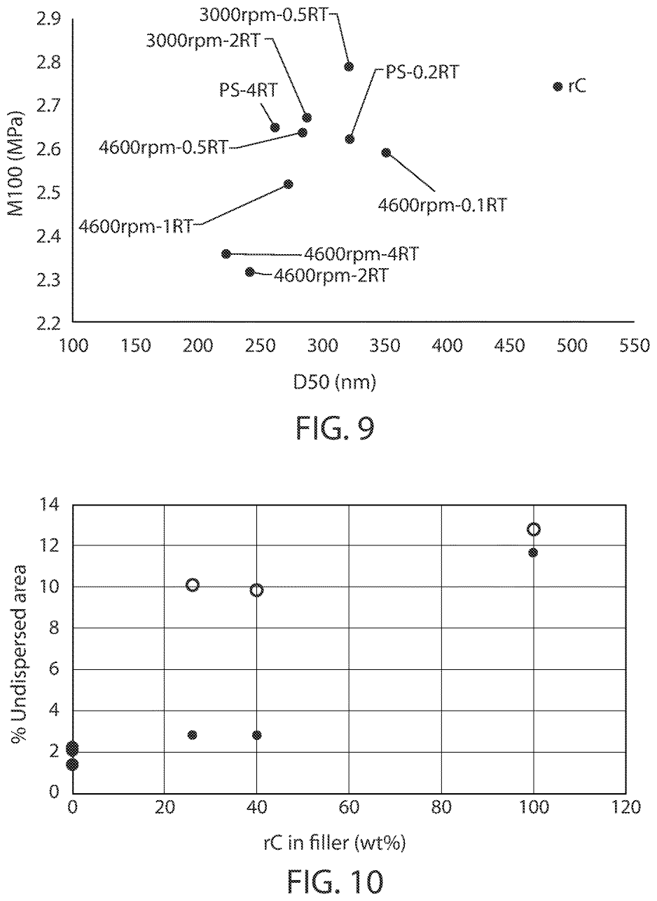

As shown in FIG. 7 (RT=residence time in minutes), even minimal milling dramatically improved dispersion in SBR compounds, with several samples, all with milled rC having D90 below 1500 nm, exhibiting undispersed area below 3 wt %. However, dispersion is imperfectly correlated with abrasion performance, with only milled rC with D90 no greater than 1100 nm delivering less than 95 mm³ of mass loss during an abrasion test (FIG. 8; RT=residence time in minutes). Moreover, only milled rC with D50 from 250 to 400 concurrently delivered M100 of at least 2.5 MPa, while milled rC with lower D50 also delivered lower moduli (FIG. 9, RT=residence time in minutes).

### Example 3

N330 CB pellets (Cabot Corporation) were jet milled to produce a fluffy material as described in Example 1. rC pellets (Reoil-RCB, REOIL S.P. Z O.O.) were jet milled, and dispersed in water at 14 wt. % to form a slurry for milling. The wet milling was carried out with a residence time of five minutes in recirculating batch mode on a MiniCer media mill (Netzsch) using 0.5 mm YSZ beads with 85% fill factor and 4600 rpm. Particle size was characterized as described in Example 1; D50 was 271 microns and D90 was 412 microns.

A portion of the milled slurry, containing 86 wt % water, was centrifuged using a Thermo Scientific Sorvall Legend XTR centrifuge for 15 minutes to obtain a centrifuge cake. Centrifuge cake was then combined with the milled slurry to form a mixed slurry having water content as indicated in Table 9. The batch was then pelletized by combining with the mixed slurry with an appropriate amount fluffy N330 carbon black in a rotary pin pelletizer operated at 900 rpm with walls heated to 50 deg C. to achieve the proportions of rC and virgin carbon black in Table 9 below. Neat rC pellets were produced by drying the centrifuge cake at 80 C until it reached a moisture content of 46%. Fluffy N330 was combined with water to achieve a solids loading of about 58 wt % for formation of neat pellets. Pellets were either dried in an oven at 80° C. or kept wet until rubber mixing, depending on the mixing method.

TABLE 9

| | Proportion of water in mixed |
|---|---|
| Proportion of rC in final pellet | rC slurry before blending |
| 26 wt % | 18% |
| 40 wt % | 26% |
| 100 wt % | 46% |

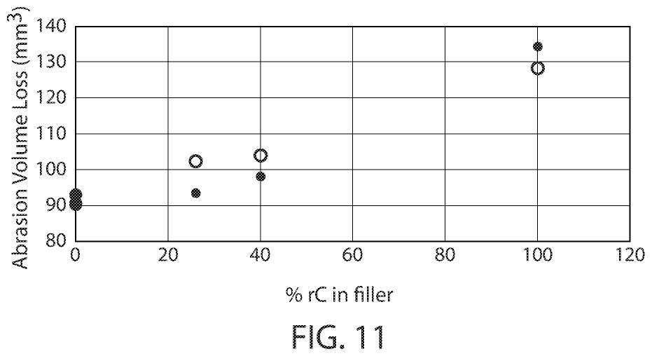

SBR composites were prepared with 50 phr (total) rC and carbon black using either the wet mixing or dry mixing protocol described in Example 1, along with the vulcanization procedure described in Example 1 using the formulation described in TABLE 8 (chemicals as described in Example 1). Rubber properties were measured as described in Example 1. As shown in FIG. 10, milling (filled circles) dramatically improves filler dispersion in comparison to samples that were not media milled (open circles), especially at 26% and 40% rC. However, at 100% rC, dried pellets exhibit a dramatic decrease in dispersion quality, while elastomer composite produced with wet pellets still maintain good dispersion performance. This correlation is also seen in abrasion performance (FIG. 11; media milled samples—closed circles; jet milled samples—open circles).

### Example 4

Copellets of 30 wt % media milled and jetmilled rC and 70% Propel E6 carbon black (STSA=97 m²/g, Cabot Corporation), along with pellets of jetmilled N330 carbon black, were prepared as described in Example 3. SBR composites with 50 phr filler were prepared as described in Example 3, except that 6PPD was sourced from Westco, and characterized as described in Example 1. As shown in Table 10 below, the use of media milled rC in combination with a higher surface area carbon black such as Propel E6 carbon black gives performance better than or equivalent to that of an N330 carbon black (STSA=76 m²/g).

TABLE 10

| | Undispersed | Abrasion loss | M300 | M100 |
|---|---|---|---|---|
| Filler | area (%) | (mm³) | (MPa) | (MPa) |
| N330 | 0.96 | 89 | 15 | 2.8 |
| Copellet with | 0.47 | 82 | 15 | 3.1 |
| media milled | | | | |
| rC | | | | |
| Copellet with | 14.7 | 94 | 13 | 2.9 |
| jetmilled rC | | | | |

While this invention has been particularly shown and described with references to preferred embodiments thereof, it will be understood by those skilled in the art that various changes in form and details may be made therein without departing from the scope of the invention encompassed by the appended claims.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. It is further understood that for any range provided herein, the numerical ranges can be “about” these ranges, and vice versa, where a range is provided using “about” ranges, these ranges can be precisely the number ranges provided. Any combination of embodiments, and/or ingredients and/or components and/or properties recited herein can be made herein and is considered part of the present invention.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. A method to process reclaimed carbon, said method comprising media milling wet reclaimed carbon to obtain milled reclaimed carbon, wherein said media milling results in 10¹³-10¹⁴ media collisions per kg of dry milled reclaimed carbon, during said milling.

2. A method to process reclaimed carbon, said method comprising media milling wet reclaimed carbon to obtain milled reclaimed carbon, wherein the milling comprises media milling that expends a specific energy of 1 kWh/kg to 10 kWh/kg of dry milled reclaimed carbon.

3. A method to process reclaimed carbon, said method comprising media milling wet reclaimed carbon to obtain milled reclaimed carbon, wherein said media milling results in a volume weighted particle size distribution of the milled reclaimed carbon measured via disc centrifuge photosedimentometry with D50 of 250-400 nm and D90 of 350 to 1100 nm.

4-11. (canceled)

12. The method of claim 1, wherein the media milling utilizing a media that is solid balls having an average size that is from about 0.25 mm to 2 mm and a volume loading of from 50% to 98% in a mill.

13-15. (canceled)

16. The method of claim 1, wherein the milling is such that a rubber sample having 10 to 50 phr milled rC has an undispersed area UA satisfying UA≤3.35−(0.04*phr rC).

17. (canceled)

18. The method of claim 1, wherein the milling is such that a rubber sample having 20 to 80 phr of particulate filler, of which 10-40 wt % is media milled reclaimed carbon, has an abrasion loss of 90 to 100 mm³, when measured according to ASTM D5963.

19. (canceled)

20. The method of claim 1, wherein the milling is such that a rubber sample having 20 to 60 phr of the milled reclaimed carbon results in a M300/M100 ratio that is either a) no more than 10% less or within 5% of a comparative rubber sample produced in the same manner but having N550 carbon black instead of the milled reclaimed carbon or b) 4.5 to 5.

21-23. (canceled)

24. Particulate filler comprising 10-40 wt % reclaimed carbon, wherein a volume weighted particle size distribution of the reclaimed carbon measured via disc centrifuge photosedimentometry has a D50 of 250-400 nm and D90 of 350 to 1100 nm.

25. (canceled)

26. The particulate filler of claim 24, further comprising one or more of carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, and carbon black-coated particles.

27-35. (canceled)

36. The particulate filler of claim 24, wherein a rubber sample having 10 to 50 phr of the reclaimed carbon has an undispersed area UA satisfying UA≤3.35−(0.04*phr rC).

37. (canceled)

38. The particulate filler of claim 24, wherein a rubber sample having 20 to 80 phr of the particulate filler has an abrasion loss of 90 to 100 mm³ when measured according to ASTM D5963.

39. The particulate filler of claim 24, wherein a rubber sample having 20 to 60 phr of the reclaimed carbon results in a M300/M100 ratio that is either a) no more than 10% less or within 5% of a comparative rubber sample produced in the same manner but having N550 carbon black instead of the reclaimed carbon or b) 4.5 to 5.

40-42. (canceled)

43. An elastomer composite comprising the particulate filler of claim 24 and at least one elastomer, and optionally further comprising one or more of carbon black, silicon treated carbon black, silica coated carbon black, precipitated silica, hydrothermal carbon, engineered polysaccharides, graphene, graphene oxide, reduced graphene oxide, nanocellulose, lignin, clays, nanoclays, metal oxides, metal carbonates, single walled carbon nanotubes, multi walled carbon nanotubes, carbon nanostructures, and carbon black-coated particles.

44-48. (canceled)

49. The elastomer composite of claim 43, wherein the elastomer composite has 10-40 phr media milled rC and an undispersed area UA satisfying UA≤3.35−(0.04*phr rC).

50. (canceled)

51. The elastomer composite of claim 43, wherein the elastomer composite has 20 to 80 phr of particulate filler and an abrasion loss of 90 to 100 mm³ when measured according to ASTM D5963.

52. The elastomer composite of claim 43, wherein the elastomer composite has 20 to 60 phr of the reclaimed carbon and a M300/M100 ratio that is either a) no more than 10% less or within 5% of a comparative rubber sample having N550 carbon black instead of the milled reclaimed carbon or b) 4.5 to 5.

53. (canceled)

54. A tire tread comprising a vulcanizate of a mixture comprising the elastomer composite of claim 43 and a curative package.

55. An article comprising a vulcanizate of a mixture comprising the elastomer composite of claim 43 and a curative package.

56. The article of claim 43, wherein the article is incorporated in pneumatic tires, non-pneumatic tires, or solid tires.

57. The article of claim 55, wherein the article is selected from tire treads, undertread, innerliners, sidewalls, sidewall inserts, wire-skim, and cushion gum for retread tires.

58. The article of claim 55, wherein the article is selected from hoses, linings, liners, seals, gaskets, anti-vibration articles, tracks, track pads for track-propelled vehicle equipment, engine mounts, earthquake stabilizers, mining equipment screens, mining equipment linings, conveyor belts, chute liners, slurry pump liners, mud pump impellers, valve seats, valve bodies, piston hubs, piston rods, plungers, impellers for mixing slurries and slurry pump impellers, grinding mill liners, cyclones and hydrocyclones, expansion joints, linings for dredge pumps and outboard motor pumps for marine equipment, shaft seals for marine, oil, aerospace, and other applications, propeller shafts, pipe linings, engine mounts, bushings, weather stripping, windshield wipers, automotive components, seals, gaskets, housings, wheel elements, and track elements.
